(19) United States
(12) Patent Application Publication
(10) Pub. No.: US 2012/0155074 A1
(43) Pub. Date: Jun. 21, 2012

(54) STRAIGHT-TUBE LED LAMP SWITCH DEVICE AND STRAIGHT-TUBE LED LAMP USING THE SAME

(75) Inventors: Toshiharu MORI, Miyagi-ken (JP); Tatsuaki KAWASE, Miyagi-ken (JP); Makoto HAYASHI, Miyagi-ken (JP); Takuya TANAKA, Miyagi-ken (JP); Syuji FUJIWARA, Miyagi-ken (JP)

(73) Assignee: Alps Electric Co., Ltd., Ota-ku (JP)

(21) Appl. No.: 13/330,130

(22) Filed: Dec. 19, 2011

(30) Foreign Application Priority Data
Dec. 20, 2010 (JP) 2010-283546
Dec. 20, 2010 (JP) 2010-283547
Sep. 21, 2011 (JP) 2011-206306

(51) Int. Cl. F21S 4/00; H01H 3/02

(52) U.S. Cl. 362/221; 200/52 R

(57) ABSTRACT

A straight-tube LED lamp switch device includes a first terminal protruding from a housing; an operating body having an operating portion that can receive a pressing operation into the housing; a second terminal that is brought into conduction with the first terminal by the pressing operation on the operating body; and a torsion spring that restores the operating body to an initial state before the pressing operation. A position of a distal end portion of the operating body in the initial state protrudes outside with respect to a distal end portion of the first terminal.

### CLAIM OF PRIORITY

This application contains information related to and claims benefit of the following Japanese Patent Applications: No. 2010-283546 filed on Dec. 20, 2010, No. 2010-283547 filed on Dec. 20, 2010, and No. 2011-206306 filed on Sep. 21, 2011. The contents of each of the aforementioned applications are hereby incorporated by reference in their entirety.

### BACKGROUND OF THE DISCLOSURE

1. Field of the Disclosure

Embodiments of the present disclosure relate to a straight-tube light-emitting diode (LED) lamp switch device that is used for a straight-tube LED lamp and is attached to a socket of a lamp fixture, and also relates to a straight-tube LED lamp using the switch device.

2. Description of the Related Art

In recent years, a LED lamp using a LED as a light source is being popular. The LED lamp can markedly reduce power consumption and carbon dioxide emission and markedly increase the life of a product as compared with a conventional lamp. A straight-tube LED lamp from among such a LED lamp is receiving attention as an alternate lamp of a conventional fluorescent lamp.

An example of this straight-tube LED lamp is suggested (for example, see Japanese Unexamined Patent Application Publication No. 2010-192229). In particular, elastically urged switch pins protrude outward from caps arranged at both ends of the straight-tube LED lamp, and portions of the switch pins pushed when the straight-tube LED lamp is attached to a fluorescent-lamp fixture change application of electricity to the LED. With this straight-tube LED lamp, a situation in which electric current flows to a worker when the straight-tube LED lamp is attached to the fluorescent-lamp fixture or when the straight-tube LED lamp is removed from the fluorescent-lamp fixture can be prevented. Hence, safety during the work can be ensured.

In the straight-tube LED lamp described in Japanese Unexamined Patent Application Publication No. 2010-192229, distal end portions of the switch pins in a non-pressed state are arranged at inner positions (positions near the caps) of distal end portions of a pair of cap pins protruding from the caps. Typically, electrodes with which the cap pins come into contact with are arranged at deep positions of holes provided at a socket of a fluorescent-lamp fixture. In the above-described straight-tube LED lamp, in a state in which the cap pins are housed in the holes, the switch pins are pushed by a surface (side surface) of the socket, so that application of electricity to the LED is changed.

However, the positions of the electrodes exposed from the holes provided at the socket of the fluorescent-lamp fixture, i.e., distances from the surface of the socket with the holes to the electrodes may vary depending on a manufacturer, an error (tolerance) in dimension of a part, and the like. Also, the position of the socket with respect to a fluorescent-lamp fixture body may vary. As described above, if the depth of the holes and the position of the socket vary, the positions of the electrodes arranged in the holes may vary. Owing to this, the switch pins may not be pushed to desired positions in accordance with the positions of the electrodes arranged in the holes of the socket. The application state of electricity to the LED may not be properly changed to an ON state.

These and other drawbacks exist.

### SUMMARY OF THE DISCLOSURE

Embodiments of the present disclosure provide a straight-tube LED lamp switch device that can reliably change an application state of electricity to a LED to an ON state even if positions of electrodes in a socket vary. The embodiments of the present disclosure also provide a straight-tube LED lamp using the straight-tube LED lamp switch device.

A straight-tube LED lamp switch device according to an aspect of the present disclosure includes a housing having an opening; a pair of first terminals that protrude from the housing in one direction and can come into contact with electrodes in a socket of a lamp fixture; an operating body including an operating portion that protrudes from the opening in the one direction and can receive a pressing operation into the housing; a second terminal, a conduction state of the second terminal with respect to one of the first terminals being changed by the pressing operation on the operating body; and an elastic member that restores the operating body to an initial state before the pressing operation. A position of a distal end portion of the operating body in the initial state protrudes in the one direction with respect to positions of distal end portions of the pair of first terminals.

With this configuration, since the position of the distal end portion of the operating body in the initial state protrudes in the one direction with respect to the positions of the distal end portions of the pair of first terminals, the operating body can come into contact with the socket of the lamp fixture before the pair of first terminals. The operating body can receive the pressing operation into the housing regardless of positions of electrodes in the socket. By the pressing operation, since the first terminal and the second terminal can be brought into conduction, even if the positions of the electrodes in the socket vary, a state can be reliably changed to an ON state in which electricity can be applied to a driving circuit that causes an LED to emit light.

In the above-described straight-tube LED lamp switch device, when the pressing operation is performed on the operating body by the socket, the operating body may be pressed into the housing by the socket before the first terminals come into contact with the electrodes, and the one of the first terminals and the second terminal may be brought into conduction. In this case, since the first terminal and the second terminal are brought into conduction before the pair of first terminals comes into contact with the electrodes, power feed is not started at the time when the first terminal and the second terminal are brought into conduction. Accordingly, arc discharge can be prevented from occurring in the switch device.

In the above-described straight-tube LED lamp switch device, the distal end portions of the first terminals may be housed in holes provided at the socket at the time when the one of the first terminals and the second terminal are brought into conduction. In this case, since the distal end portions of the first terminals may be housed in the holes provided at the socket at the time when the one of the first terminals and the second terminal are brought into conduction, a worker hardly contacts the first terminals, for example, when the worker attaches the straight-tube LED lamp. Accordingly, safety during the work can be ensured.

In the above-described straight-tube LED lamp switch device, the housing may have therein a housing portion that houses the operating portion when the pressing operation is performed on the operating body. The operating body may be tilted by a pressing operation from at least one side of opposite directions with respect to the one direction of the first terminals. By the tilting, at least part of the operating portion may be housed in the housing portion, and the one of the first terminals and the second terminal may be brought into conduction. In this case, at least the part of the operating portion may be housed in the housing by the pressing operation into the housing and the pressing operation from at least one side of the opposite directions with respect to the protruding directions of the first terminals. Hence, the first terminal and the second terminal are brought into conduction. Accordingly, even when the switch device is attached to a fluorescent-lamp fixture of any of a type configured such that a terminal at one end of a straight-tube fluorescent lamp is inserted into one socket and then a terminal at the other end is inserted into the other socket and a type configured such that terminals at both ends of a straight-tube fluorescent lamp are simultaneously attached to sockets, the operating body can be housed in the housing portion and the first terminal can be brought into conduction with the second terminal. The switch device can be attached to any type of the fluorescent-lamp fixture.

In the above-described straight-tube LED lamp switch device, the housing portion may include a guide portion that guides the operating body when the operating portion is housed by the pressing operation on the operating body. The operating portion may include a first pressed portion that receives a pressing operation from the one side. The operating body may be tilted and pushed into the housing portion by the pressing operation from the one side. In this case, since the operating body may include the first pressed portion that receives the pressing operation from the one side, the operating body can be tilted and pushed into the housing portion in accordance with the pressing operation from the one side with a simple configuration. Also, since the housing portion may include the guide portion that guides the operating body to the housing portion, the operating portion can be smoothly housed in the housing portion by the pressing operation.

In the above-described straight-tube LED lamp switch device, a cross-sectional shape of the operating portion in a cross-sectional plane parallel to a plane containing extending directions of both the pair of first terminals may have a smaller width at a vertex portion at a distal end than a width at a portion near the opening. The first pressed portion may be provided at one outline portion with respect to the vertex portion of the cross-sectional shape. The tilting by the pressing operation from the one side may be movement along the plane containing the extending directions of both the pair of first terminals. In this case, since the operating portion may move along the plane containing the extending directions of both the pair of first terminals, the straight-tube LED lamp can be easily attached to a fluorescent-lamp fixture of a type configured such that terminals at both ends of a straight-tube fluorescent lamp are simultaneously attached to sockets.

In the above-described straight-tube LED lamp switch device, the operating body may include a protrusion protruding in a direction intersecting with the cross-sectional plane. In the initial state, the protrusion may be supported by a support portion provided at the housing portion. In this case, since the protrusion may be received by the support portion using an urging force of the elastic member, the operating body can be prevented from rattling. Also, the protrusion serves as a stopper and hence the operating body can be prevented form being dropped from the opening.

In the above-described straight-tube LED lamp switch device, the operating body may include a second pressed portion that receives a pressing operation from the other side opposite to the one side with respect to the one direction of the first terminals. The operating body may be tilted and pushed into the housing portion by the pressing operation from the other side. The first pressed portion and the second pressed portion may respectively have a first inclination portion and a second inclination portion having angles smaller than 90 degrees with respect to a surface of the housing having the opening. When one inclination portion of the first inclination portion and the second inclination portion comes into contact with the guide portion of the housing portion by the tilting as the result of the pressing operation from the one side or the other side, the other inclination portion may protrude from the opening. In this case, singe the operating body may be tilted by the pressing operation from both sides of the one side and the other side, limitation for an attachment direction to the fluorescent-lamp fixture can be eliminated. Attachment work of a straight-tube LED lamp to a fluorescent-lamp fixture can be easily performed. Also, in this case, since the other inclination portion may protrude from the opening even if the one inclination portion of the first inclination portion and the second inclination portion comes into contact with the guide portion of the housing portion by the tilting, the pressing after the tilting can be reliably performed, and conduction between the first terminal and the second terminal can be ensured.

The above-described straight-tube LED lamp switch device may further include a movable contact that changes a conduction state between the one of the first terminals and the second terminal; and a driving member that is moved by the pressing operation on the operating body and drives the movable contact. The driving member may be arranged to move in a region between the pair of first terminals. In this case, since the driving member may be arranged to move in the region between the pair of first terminals, space utilization efficiency in the housing is increased.

In the above-described straight-tube LED lamp switch device, the operating body may be arranged in a region different from the region between the pair of first terminals, and may include a contact portion that is arranged at a position opposite to a distal end of the operating portion and that comes into contact with the driving member. The driving member may include a support portion that supports the contact portion, and the support portion may be urged to the contact portion by the elastic member. In this case, since the operating body may be arranged in the region different from the region between the pair of first terminals, even if a dent is present at a center portion of the socket, the operating body can receive the pressing operation into the housing. Also, since the operating body may include the contact portion and the driving member may include the support portion that supports the contact portion, an additional member does not have to be provided and the operating body can be restored with a simple configuration. Accordingly, space utilization efficiency can be further increased.

In the above-described straight-tube LED lamp switch device, the contact portion of the operating body may be a recess, and the support portion of the driving member may be a protrusion. In this case, since the support portion that is the protrusion may support the contact portion that is the recess, the switch device can be downsized in the height direction.

In the above-described straight-tube LED lamp switch device, the housing portion that houses the operating portion may be provided in one region in the housing with respect to the plane containing the extending directions of both the pair of first terminals, and a movable contact that changes a conduction state between the one of the first terminals and the second terminal may be provided in the other region in the housing with respect to the plane containing the extending directions of both the pair of first terminals. In this case, since the operating portion may be housed in the one region in the housing with respect to the plane containing the extending directions of both the pair of first terminals and the movable contact is provided in the other region, the space in the housing can be efficiently used. The components can be efficiently housed in the housing, and working efficiency when the components are assembled can be increased.

In the above-described straight-tube LED lamp switch device, the movable contact may be formed of a member different from the first terminals and the second terminal, may be arranged to face a first contact that is provided in conduction with the one of the first terminals and a second contact that is provided in conduction with the second terminal, and may come into contact with the first contact and the second contact by the pressing operation on the operating body. In this case, since the movable contact may be formed of the member different from the first terminals and the second terminal, an insulation distance between the contacts can be ensured. The level of insulation performance can be increased and the level of safety can be increased.

In the above-described straight-tube LED lamp switch device, the operating body may have a recess to face a distal end of the operating portion. A driving member being able to perform a seesaw motion may be arranged to pass through a region between the pair of first terminals, one end portion of the driving member being arranged in the recess, the other end portion of the driving member driving the movable contact. The one end portion of the driving member may be urged to the recess by the elastic member. In this case, since the driving member may be arranged to pass through the region between the pair of first terminals, the space utilization efficiency in the housing can be further increased. Also, since the driving member may perform the seesaw operation and drive the movable contact, the conduction state between the movable contact and the first contact, and between the movable contact and the second contact can be stably changed.

In the above-described straight-tube LED lamp switch device, a pair of the second terminals and a pair of the movable contacts may be provided respectively for the pair of first terminals. Conduction states may be changed through the movable contacts respectively corresponding to the first terminals and the second terminals. In this case, since the pair of second terminals and the pair of movable contacts may be provided for the pair of first terminals, for example, this configuration can be applied to a straight-tube LED lamp with a power-feed structure from one straight-tube LED lamp switch device provided at an end of a lamp body.

A straight-tube LED lamp according to an aspect of the present disclosure includes a plurality of LEDs; a driving circuit that causes the LEDs to emit light; a cylindrical lamp body that houses the plurality of LEDs and the driving circuit; and any of the above-described straight-tube LED lamp switch devices provided at an end of the lamp body.

### BRIEF DESCRIPTION OF THE DRAWINGS

FIG. 1 is an exploded perspective view showing a general configuration of a straight-tube LED lamp switch device according to an embodiment of the present disclosure;

FIG. 2 is an external perspective view of the straight-tube LED lamp switch device according to an embodiment of the present disclosure;

FIG. 3 is a sectional side view of an outer case and an inner case of the straight-tube LED lamp switch device according to an embodiment of the present disclosure;

FIG. 4 is a sectional side view of the straight-tube LED lamp switch device according to an embodiment of the present disclosure;

FIG. 5 is a perspective view for explaining components in the periphery of the inner case of the straight-tube LED lamp switch device according to an embodiment of the present disclosure;

FIG. 6 is a top view of the inner case and its peripheral components in a state shown in FIG. 5;

FIG. 7 is an explanatory view of a positional relationship among components in the straight-tube LED lamp switch device according to an embodiment of the present disclosure;

FIGS. 8A and 8B are explanatory views of a positional relationship among the components in the straight-tube LED lamp switch device according to an embodiment of the present disclosure;

FIG. 9 is a top view for explaining the positional relationship among the components in the straight-tube LED lamp switch device shown in FIG. 7;

FIG. 10 is a perspective view showing an appearance of a straight-tube LED lamp with the straight-tube LED lamp switch device according to an embodiment of the present disclosure being attached;

FIGS. 11A and 11B are perspective views showing a state of the straight-tube LED lamp switch device immediately before the switch device is attached to a fluorescent-lamp fixture A;

FIG. 12 is a perspective view showing a state of the components in the straight-tube LED lamp switch device when the switch device is attached to the fluorescent-lamp fixture A;

FIGS. 13A to 13C are schematic illustrations for explaining a relationship between first terminals and an operating body when the straight-tube LED lamp according to an embodiment of the present disclosure is attached to the fluorescent-lamp fixture A;

FIGS. 14A and 14B are perspective views showing a state of the straight-tube LED lamp switch device immediately before the switch device is attached to a fluorescent-lamp fixture B;

FIG. 15 is a perspective view showing a state of the components in the straight-tube LED lamp switch device when the switch device is attached to the fluorescent-lamp fixture B;

FIG. 16 is an exploded perspective view showing a general configuration of a straight-tube LED lamp switch device according to an embodiment of the present disclosure;

FIG. 17 is a perspective view of an outer case of the straight-tube LED lamp switch device according to an embodiment of the present disclosure;

FIG. 18 is a sectional side view of the straight-tube LED lamp switch device according to an embodiment of the present disclosure;

FIG. 19 is a perspective view for explaining components in the periphery of an inner case of the straight-tube LED lamp switch device according to an embodiment of the present disclosure;

FIG. 20 is a top view of the inner case and its peripheral components in a state shown in FIG. 19;

FIG. 21 is an explanatory view of a positional relationship among components in the straight-tube LED lamp switch device according to an embodiment of the present disclosure;

FIG. 22 is a perspective view showing a state of the components in the straight-tube LED lamp switch device when the switch device is attached to the fluorescent-lamp fixture A;

FIG. 23 is a perspective view showing a state of the components in the straight-tube LED lamp switch device when the switch device is attached to the fluorescent-lamp fixture B;

FIGS. 24A to 24C are explanatory views of modifications of operating bodies of the straight-tube LED lamp switch device according to an embodiment of the present disclosure; and

FIG. 25 is an explanatory view of a modification of an operating body of the straight-tube LED lamp switch device according to the embodiment.

### DETAILED DESCRIPTION OF THE DISCLOSURE

Embodiments of the present disclosure will be described below with reference to the attached drawings.

The following description is intended to convey a thorough understanding of the embodiments described by providing a number of specific embodiments and details involving a straight-tube LED lamp switch device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. Embodiments of the present invention will be described below with reference to the attached drawings.

A straight-tube LED lamp switch device (hereinafter, merely referred to as “switch device”) according to an exemplary embodiment of the present disclosure may be provided at an end of a straight-tube LED lamp, and may changes a application state of electricity to a driving circuit (for example, AC/DC converter) mounted in the straight-tube LED lamp. In particular, this switch device can be attached to a fluorescent-lamp fixture of a type configured such that a terminal at one end of a straight-tube fluorescent lamp may be inserted into one socket and then a terminal at the other end may be inserted into the other socket (hereinafter, occasionally referred to as “first-type fluorescent-lamp fixture”) and a fluorescent-lamp fixture of a type configured such that terminals at both ends of a straight-tube fluorescent lamp may be simultaneously attached to sockets (hereinafter, occasionally referred to as “second-type fluorescent lamp fixture”).

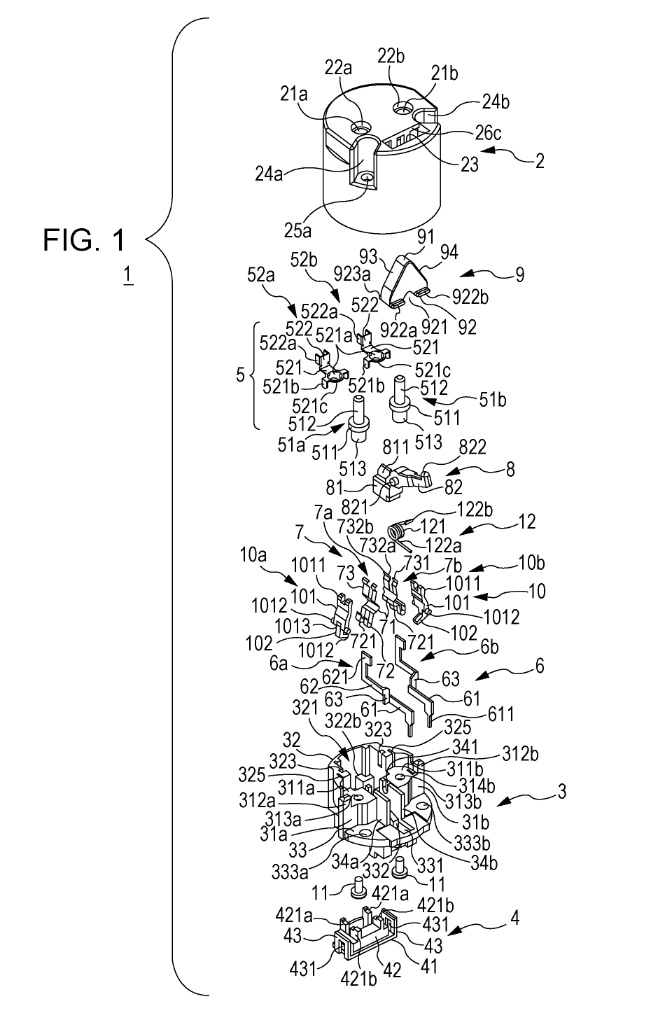

FIG. 1 is an exploded perspective view showing a general configuration of a switch device 1 according to the first embodiment of the present invention. In the following description, the upper left side in FIG. 1 is called “rear side of switch device 1” or merely “rear side,” and the lower right side in FIG. 1 is called “front side of switch device 1” or merely “front side.”

As shown in FIG. 1, the switch device 1 according to this embodiment may include an outer case 2 that may form a housing of a device body, an inner case 3, and an insulating cover 4; and first terminals 5 and second terminals 6 that are attached to the inner case 3. Components, such as movable contacts 7, a driving member 8, an operating body 9, and cam bodies 10, for example, may be housed in an inner space that is formed when the outer case 2 is assembled with the inner case 3. The outer case 2 that forms the housing, the inner case 3, and the insulating cover 4; and the driving member 8, the operating body 9, and the cam bodies 10 that are housed in the inner space may be molded with, for example, an insulating resin material.

The outer case 2 may have a substantially cylindrical shape that is open to the lower side. A pair of through holes 21a and 21b may be formed in an upper surface of the outer case 2. Circular recesses 22a and 22b may be respectively formed in the peripheries of the through holes 21a and 21b. The recesses 22a and 22b may have an outer diameter slightly larger than an outer diameter of the through holes 21a and 21b. Hence, bottom walls may be provided at circumferences of the through holes 21a and 21b in the recesses 22a and 22b.

Also, a rectangular opening 23 may be formed in the upper surface of the outer case 2 at a position near the front side of the switch device 1. Sides in the longitudinal direction of the opening 23 may be arranged in parallel to a plane that passes through the pair of through holes 21a and 21b. A pair of recesses 24a and 24b may be formed at the outer periphery of the outer case 2, at positions at the lateral sides of the opening 23. The recesses 24a and 24b may extend to positions near a center portion of the outer case 2. Through holes 25a and 25b may be formed in bottom surfaces of the recesses 24a and 24b (the through hole 25b is not shown in FIG. 1). The through holes 25a and 25b may be used when the switch device 1 is fixed to a lamp body by fixing members such as screws (not shown).

The inner case 3 may have a substantially circular shape in top view. The inner case 3 may have an outer diameter corresponding to an inner periphery shape of the outer case 2. A pair of walls 31 (31a, 31b) extending in the up-down direction may be provided at the center of the inner case 3. The walls 31a and 31b may be arranged side by side at a constant distance provided therebetween in the left-right direction of the switch device 1. A cylindrical portion 32 having a substantially semicircular shape may be provided at a rear portion of the inner case 3 with respect to the walls 31a and 31b. A disk-like portion 33 having a substantially semicircular shape may be provided at a front portion of the inner case 3 with respect to the walls 31a and 31b. The disk-like portion 33 may extend from lower portions of the walls 31.

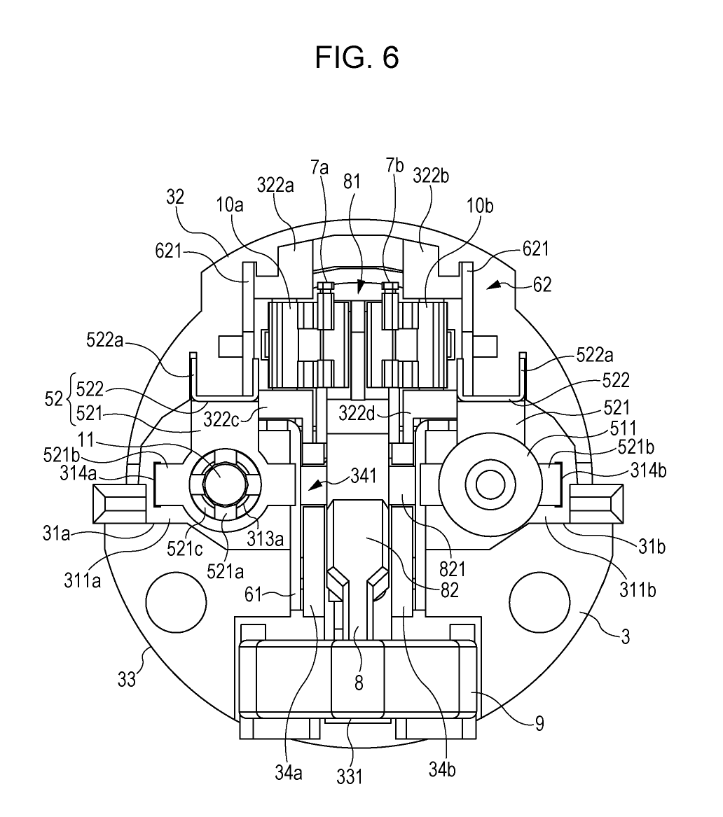

Flat surfaces 311 (311a, 311b) may be provided at inner portions of upper surfaces of the pair of walls 31. Columnar portions 312 (312a, 312b) may be provided outside the flat surfaces 311. Insertion holes 313 (313a, 313b) may be formed at positions near the centers of the flat surfaces 311. Fixing screws 11 (described later) may be inserted into the insertion holes 313. Also, slits 314 (314a, 314b) may be formed in the flat surfaces 311, at positions near the columnar portions 312 (the slit 314a is not shown in FIG. 1, see FIG. 6). Portions of holders 52 that form the first terminals 5 may be inserted into the slits 314. Tapered surfaces may be formed at upper ends of the columnar portions 312. The tapered surfaces function as guide portions when the inner case 3 is housed in the outer case 2.

A housing portion 321 having a substantially rectangular shape in top view may be provided in the cylindrical portion 32. The housing portion 321 may penetrate through the cylindrical portion 32 in the up-down direction. Although it is described later in detail, the movable contacts 7, the cam bodies 10 held thereby, and part of the driving member 8 may be housed in the housing portion 321. Support portions 322a to 322d having substantially rectangular-parallelepiped shapes may be provided at four corners of inner wall surfaces that define the housing portion 321 (the support portions other than the support portion 322b are not shown in FIG. 1, see FIG. 6). Recesses (not shown) having a substantially semicircular shape may be formed at lower surfaces of the support portions 322a to 322d. The recesses may have dimensions that can house shafts 1012 of the cam bodies 10 (as described below, for example) from the lower side.

Also, recesses 323 with a predetermined depth may be provided at upper end portions of a pair of facing inner wall surfaces from among the inner wall surfaces that define the housing portion 321. The recesses 323 may be provided at positions for housing ribs (not shown) provided on a back surface of an upper surface portion of the outer case 2. The ribs housed in the recesses 323 may insulate the first terminals 5 and the second terminals 6 attached to the inner case 3 from each other. Further, slits 325 may be formed near the recesses 323. Portions of the holders 52 (as described below, for example) may be inserted into the slits 325.

A pair of support walls 34 (34a, 34b) may be arranged between the pair of walls 31. The support walls 34 may be vertically arranged on an upper surface of the disk-like portion 33. The support walls 34 may extend to substantially the same position as the upper surfaces of the walls 31. Recesses 341 having a substantially semicircular shape may be formed at rear sections of upper end portions of the support walls 34. The recesses 341 may house shafts 821 of the driving member 8 (as described below, for example) and may rotatably support the shafts 821. The pair of support walls 34a and 34b may be arranged with gaps interposed with respect to inner portions of the pair of walls 31a and 31b. Portions of the first terminals 5 and portions of the second terminals 6 may be arranged in the gaps.

A recess 331 may be provided at the upper surface of the disk-like portion 33, at a position between the pair of support walls 34. The recess 331 may house a torsion spring 12 (as described below, for example). A protruding piece 332 may be provided at an upper surface of the recess 331. The protruding piece 332 may position a wound portion 121 of the torsion spring 12. Also, a pair of through holes 333 (333a, 333b) may be formed at predetermined positions of the disk-like portion 33. The through holes 333a and 333b may be used when the switch device 1 is fixed to the lamp body by fixing members such as screws (not shown).

The insulating cover 4 may include a bottom portion 41 having a substantially rectangular shape, an insertion portion 42 provided at the center of an upper surface of the bottom portion 41, and fixing portions 43 provided at a pair of facing end portions of the bottom portion 41 and extending upward. The insertion portion 42 may have an outline corresponding to the inner wall of the housing portion 321 formed at the cylindrical portion 32 of the inner case 3. The housing portion 321 may be closed with the insertion portion 42. Accordingly, reliable insulation may be ensured with respect to the movable contacts 7 and other components housed in the housing portion 321.

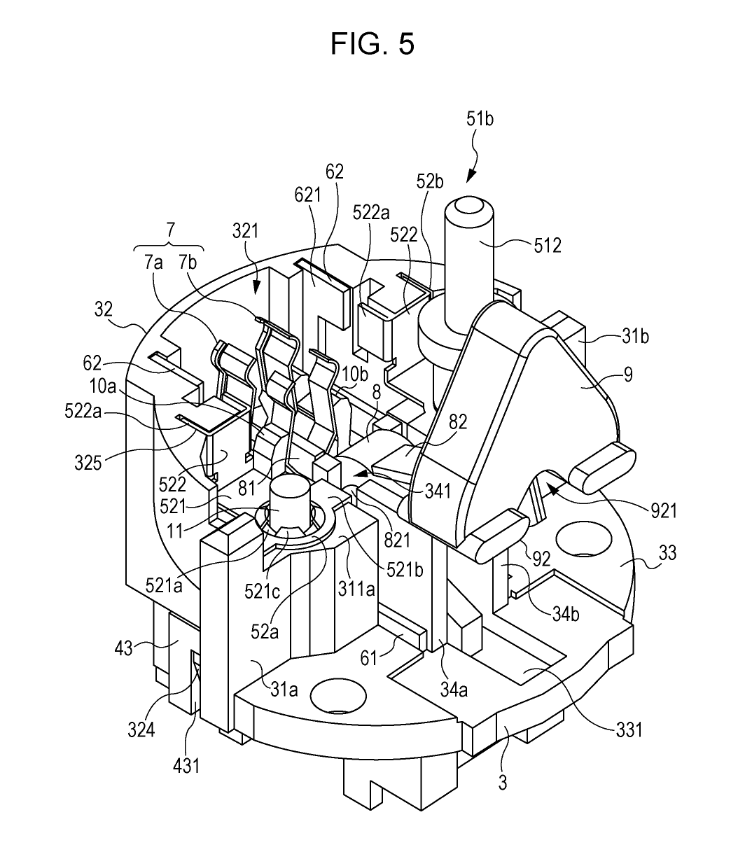

A pair of support pieces 421a and 421b may be provided near each of a pair of facing ends of the insertion portion 42. The support pieces 421a and 421b may support the shafts 1012 of the cam bodies 10 housed in the recesses at the lower surfaces of the support portions 322a to 322d, from the lower side. The fixing portions 43 may fix the insulating cover 4 to the inner case 3. Openings 431 may be respectively formed at the centers of the fixing portions 43. The openings 431 may house protruding pieces 324 (not shown in FIG. 1, see, e.g., FIG. 5) provided at an outer surface of the cylindrical portion 32. Accordingly, the insulating cover 4 may be fixed to the inner case 3.

The first terminals 5 each may include a pair of cap pins 51 (51a, 51b) and holders 52 (52a, 52b). The cap pins 51 may be formed by machining a conductive metal material. The cap pins 51 each may have a substantially columnar shape. Collars 511 are respectively provided near the centers of the cap pins 51. Columnar connection portions 512 respectively may be provided at the upper side of the collars 511. Also, cylindrical fixing portions 513 re respectively may be provided at the lower side of the collars 511. Each fixing portion 513 may have a larger outer diameter than an outer diameter of each connection portion 512. Thread grooves may be formed at lower surfaces of the fixing portions 513. Fixing screws 11 may be fixed to the thread grooves.

The holders 52 may be formed by punching and bending conductive metal plates. The holders 52 each may include a flat surface 521, and a vertical surface 522 formed by bending a rear end portion of the flat surface 521 perpendicularly upward. A circular opening 521a may be formed at the center of a front portion of the flat surface 521. A pair of arms 521b may be provided at lateral sides of the opening 521a. The arms 521b may extend downward. A plurality of conductive pieces 521c may be provided at an inner peripheral portion of the opening 521a. The conductive pieces 521c may be pressed to the lower surfaces of the fixing portions 513 of the cap pins 51. A pair of bent portions 522a may be provided at side edges of each of the vertical surfaces 522. The bent portions 522a may extend to the rear side. The bent portions 522a may be arranged at the inner side form first contacts. The first contacts and second contacts (as described below, for example) may form fixed contacts. The movable contacts 7 may come into contact with and may be separated from the fixed contacts.

The second terminals 6 (6a, 6b) may be formed by punching and bending conductive metal plates. The second terminals 6 (6a, 6b) each may include a front terminal 61 and a rear terminal 62 that may be arranged in parallel to each other, and a coupling portion 63 that may couple the front terminal 61 with the rear terminal 62. The front terminal 61 and the rear terminal 62 may extend in the front-rear direction of the switch device 1. The coupling portion 63 may be arranged orthogonally to the front terminal 61 and the rear terminal 62.

The front terminal 61 may be provided at an inner side of a lower end of the coupling portion 63. The rear terminal 62 may be provided at an outer side of an upper end of the coupling portion 63. The second terminals 6a and 6b may differ from each other in that the front terminals 61 and the rear terminals 62 are provided at different positions with respect to the coupling portions 63. A front end portion of each of the front terminals 61 may have a downward bent shape. A connection portion 611 may be provided at a distal end of the downward bent shape. A lower end portion of the connection portion 611 may be exposed from a lower surface of the inner case 3, and may be connected to a connected terminal of the LED lamp body. A rear end portion of each of the rear terminals 62 may have an upward bent shape. A rectangular portion 621 may be provided at a distal end of the upward bent shape. The rectangular portion 621 may form the second contact.

The movable contacts 7 (7a, 7b) may be formed by punching and bending conductive metal plates. The movable contacts 7 each may include a base 71 provided at a center portion, a holder 72 provided to extend from a lower end of the base 71, and a contact 73 provided to extend from an upper end of the base 71. The base 71 may have a protrusion having an arc-like shape and protruding inward. The holder 72 may have a U-like shape in front view (in rear view). The holder 72 may hold a lower end portion of a base 101 of the cam body 10 (as described below, for example). A rectangular opening 721 may be formed at the center of the holder 72. The opening 721 may be arranged such that the longitudinal direction thereof may extend along the up-down direction. The opening 721 may be formed along a U-like portion. The opening 721 may allow an engagement piece 102 of the cam body 10 (as described below, for example) to protrude and to be engaged with a protruding piece 1013 of the cam body 10 (described later).

The contacts 73 each may include a first movable contact 731 and a second movable contact 732. The first movable contact 731 and the second movable contact 732 may be arranged to be separated from each other by a constant distance. Arc-like portions may be provided near upper ends of the first movable contact 731 and the second movable contact 732. The arc-like portions may protrude outward. The second movable contact 732 may include a main contact 732a and an auxiliary contact 732b formed by dividing the second movable contact 732. In the switch device 1, the second movable contact 732 may be formed of a plurality of contacts including the main contact 732a and the auxiliary contact 732b. Accordingly, stability of contact may be ensured.

The driving member 8 may include a driving portion 81 provided at the rear side and a lever 82 extending from a front end portion of an upper surface of the driving portion 81 to the obliquely upper side. The driving portion 81 may have a substantially rectangular-parallelepiped shape. A plate portion 811 may be provided at the center of the upper surface of the driving portion 81. The plate portion 811 may extend upward. The plate portion 811 may prevent the bases 71 of the facing movable contacts 7a and 7b from coming into contact with each other.

The pair of shafts 821 may be provided near a rear end of the lever 82 (a coupling portion to the driving portion 81). The shafts 821 may extend in the left-right direction of the switch device 1. Also, a slightly protruding pressed portion 822 may be provided at a front end portion of an upper surface of the lever 82. A surface of the pressed portion 822 may have a substantially spherical shape. As described above, since the surface of the pressed portion 822 is spherical, the driving member 8 can be moved up and down flexibly in accordance with pressing or tilting of the operating body 9.

The torsion spring 12 that forms an elastic member may be arranged below the driving member 8. The torsion spring 12 may include the wound portion 121 and a pair of arms 122a and 122b extending from both ends of the wound portion 121. The one arm 122a may extend forward horizontally from a position near a lower end of the wound portion 121. The other arm 122b may extend forward to the obliquely upper side from a position near an upper end of the wound portion 121. A distal end of the arm 122b may be bent to the lateral side, and hence the arm 122b may have a substantially L-like shape.

The operating body 9 may be formed such that a cross-sectional shape of the operating body 9 in a cross-sectional plane parallel to a plane containing extending directions of both the pair of first terminals 5 (the cap pins 51) may have a smaller width at an upper portion than a width at a lower portion. For example, the operating body 9 may have a substantially triangular shape in front view. The operating body 9 may include a vertex portion 91 that is a distal end portion arranged at an upper end, a bottom surface 92 opposite to the vertex portion 91, a first pressed portion 93 provided at one outline portion with respect to the vertex portion 91, and a second pressed portion 94 provided at the other outline portion different from the first pressed portion 93 with respect to the vertex portion 91. The vertex portion 91, the first pressed portion 93, and the second pressed portion 94 may form an operating portion of the operating body 9.

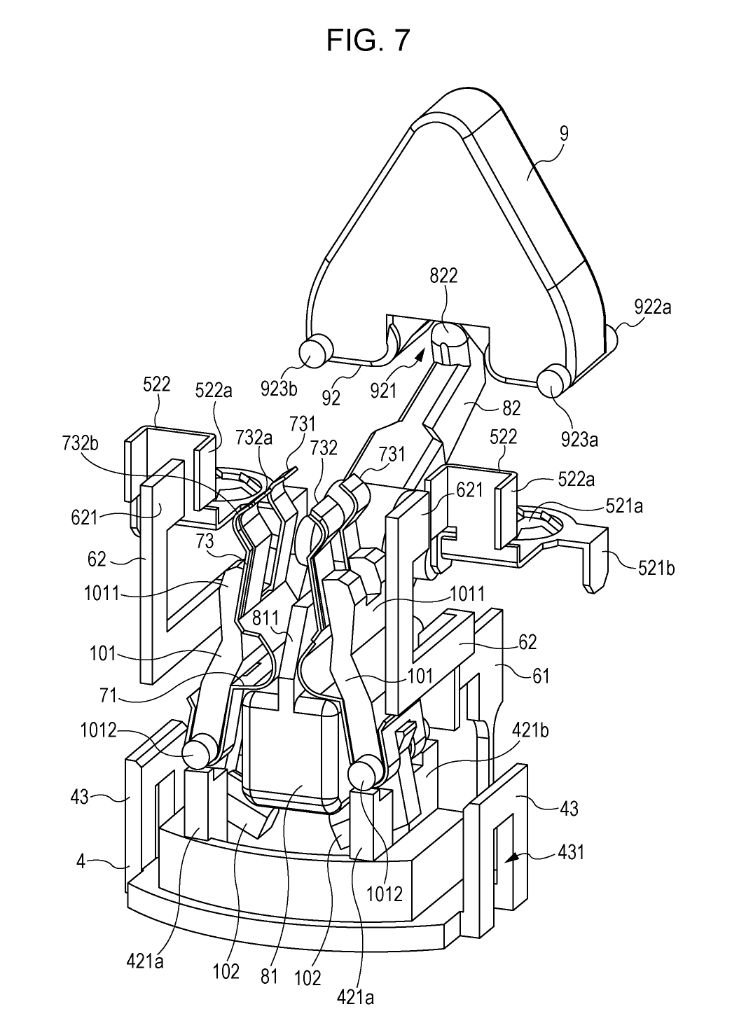

A recess 921 may be provided at the center of the bottom surface 92. The recess 921 may be provided for housing the pressed portion 822 of the driving member 8. The recess 921 may be a contact portion that comes into contact with the driving member 8. The pressed portion 822 of the driving member 8 may function as a support portion that supports the contact portion. Also, since the pressed portion 822 has a protruding shape, the support portion that may be a protrusion (the pressed portion 822) may support the contact portion that may be a recess (the recess 921). Accordingly, the switch device 1 can be downsized in the height direction. A pair of protrusions 922a and 922b may be provided at a lower end portion of a front surface of the operating body 9. The protrusions 922a and 922b each may have a dimension corresponding to a length from an end of the bottom surface 92 to an end of the recess 921. Arc-like tapered surfaces may be provided at both ends of each of the protrusions 922a and 922b. Also, a pair of protrusions 923a and 923b may be provided at a lower end portion of a rear surface of the operating body 9 (the protrusion 923b is not shown in FIG. 1, see FIG. 7). The protrusions 923a and 923b may be arranged near ends of the bottom surface 92 and each have a columnar shaft-like shape.

The cam bodies 10 (10a, 10b) each may include the base 101 extending in the up-down direction, and the engagement piece 102 provided at a lower end of the base 101. Contact portions 1011 may be provided at upper portions of the bases 101. The contact portions 1011 can press the movable contacts 7 (7a, 7b). The shafts 1012 may be provided at lower end portions of front and rear surfaces of the bases 101. Also, the protruding pieces 1013 may be provided at lower end portions of side surfaces of the bases 101. The protruding pieces 1013 may be engaged with the openings 721 formed at the movable contacts 7 (7a, 7b).

The engagement pieces 102 may form pressed portions that receive a pressure from the driving portion 81 of the driving member 8. The engagement pieces 102 may extend downward from lower ends of the bases 101, and each may have a shape bent inward (substantially L-like shape) at the lower ends. The engagement pieces 102 have dimensions such that the engagement pieces 102 can pass through the openings 721. Distal end portions of the engagement pieces 102 may protrude inward with respect to the positions of the holders 72 of the movable contacts 7 when the cam bodies 10 (10a, 10b) are held at the movable contacts 7 (7a, 7b).

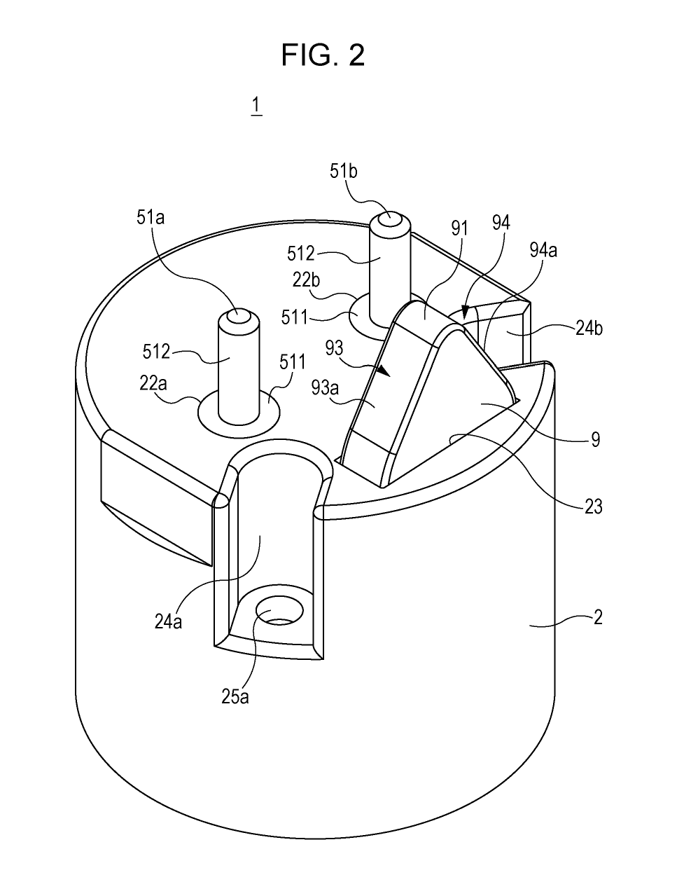

FIG. 2 is an external perspective view of an exemplary switch device 1. As shown in FIG. 2, in the switch device 1, the first terminals 5 (the cap pins 51a and 51b) may be fixed such that the first terminals 5 may protrude from the upper surface of the outer case 2. The first terminals 5 may be fixed such that the collars 511 may be housed in the recesses 22a and 22b, and the connection portions 512 may protrude. Also, in the switch device 1, the operating body 9 may be held such that part of the operating body 9 may be exposed from the opening 23 of the outer case 2.

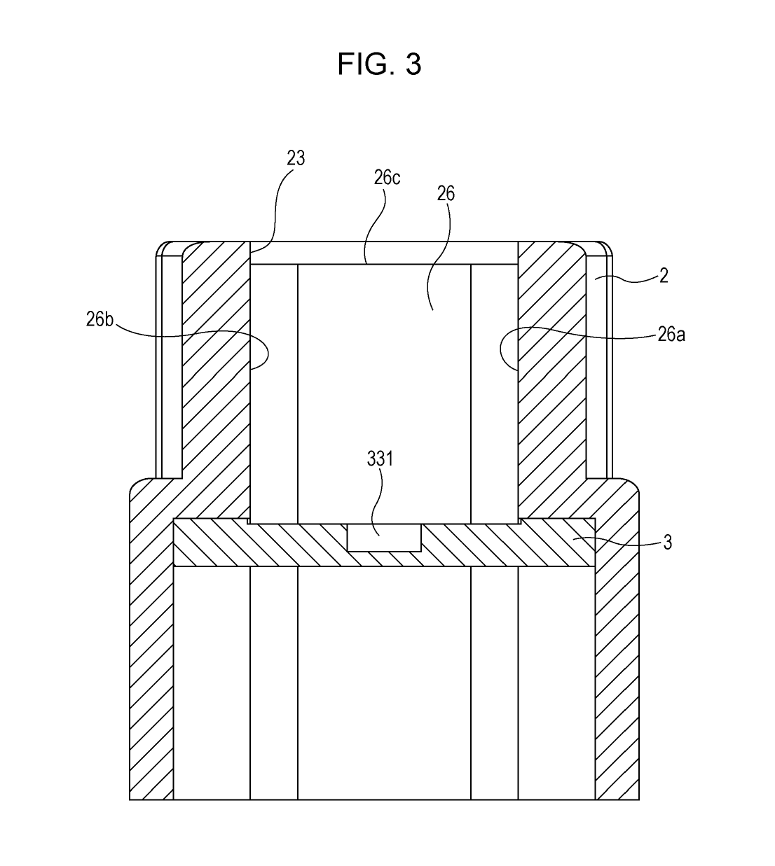

In an initial state without a pressing operation, the first pressed portion 93 and the second pressed portion 94 of the operating body 9 may respectively have a first inclination portion 93a and a second inclination portion 94a having angles smaller than 90 degrees with respect to the flat-surface-like upper surface of the outer case 2. The operating body 9 held as described above can receive a pressing operation by the vertex portion 91, the first pressed portion 93, and the second pressed portion 94 forming the operating portion. FIG. 3 is a sectional side view of the outer case 2 and the inner case 3 of the switch device 1. FIG. 3 shows a cross section that passes through the center of the operating body 9 when viewed from the rear side to the front side of the switch device 1. The outer case 2 may have a housing portion 26 inside the opening 23. The housing portion 26 can house part of or the whole of the operating body 9. Inner wall surfaces 26a and 26b of the outer case 2 forming the housing portion 26 may function as guide portions when the operating body 9 moves to the inside.

Also, a support wall 26c forming a support portion may be provided at an upper end portion of the housing portion 26. The support wall 26c may protrudes slightly to the near side of the drawing in FIG. 3. Another support wall 26c also may be provided at an upper end portion at the other side of the housing portion 26 (see, e.g., FIG. 1). The support walls 26c may come into contact with the protrusions 922 (922a, 922b) and the protrusions 923 (923a, 923b) of the operating body 9 and position the operating body 9 at an initial position. When the operating body 9 receives an urging force of the torsion spring 12 through the driving member 8, the operating body 9 may be held at the initial position by the support walls 26c.

As described above, in the switch device 1 according to this embodiment, the operating body 9 may be held at the initial position by the support walls 26c provided at the upper end portion of the housing portion 26 of the outer case 2. Accordingly, the operating body 9 can be prevented from being dropped from the outer case 2. Also, since the operating body 9 is held at the initial position by using the urging force of the torsion spring 12, the operating body 9 can be prevented from rattling in an operated state.

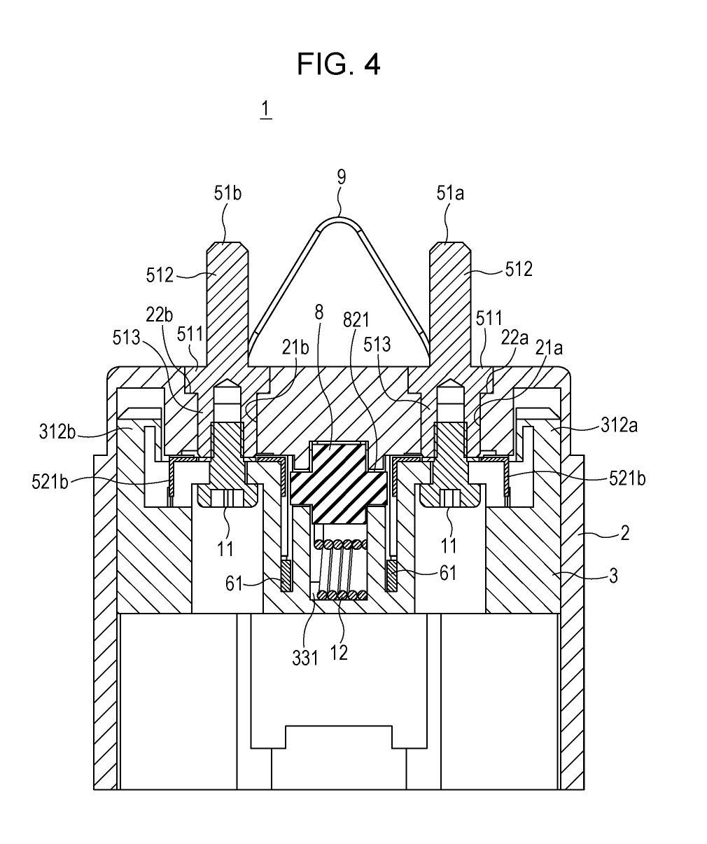

FIG. 4 is a sectional side view of the switch device 1. FIG. 4 shows a cross section that passes through the centers of the cap pins 51a and 51b. As shown in FIG. 4, the outer case 2 may house therein components, such as the driving member 8 and the torsion spring 12; and the inner case 3 with the holders 52 of the first terminals 5 and the second terminals 6 attached. The inner case 3 may be unitized with the outer case 2 by inserting the cap pins 51a and 51b into the through holes 21a and 21b while the inner case 3 may be housed in the outer case 2, and by fixing the cap pins 51a and 51b with the fixing screws 11 from the lower side.

FIG. 5 is a perspective view for explaining components in the periphery of the inner case 3 of the switch device 1. FIG. 5 corresponds to a state in which the outer case 2 is removed from the switch device 1 shown in FIG. 2. In FIG. 5, illustration of the cap pin 51a of the first terminal 5 is omitted for convenience of the description. FIG. 6 is a top view of the inner case 3 and its peripheral components in a state shown in FIG. 5.

As shown in FIGS. 5 and 6, the driving member 8 may be arranged in the inner case 3. The driving member 8 may be arranged in a space between the support walls 34 (34a, 34b) such that the shafts 821 provided at the lever 82 may be housed in the recesses 341 of the support walls 34 (34a, 34b). Protruding pieces (not shown) provided at a lower surface of the outer case 2 may be arranged above the shafts 821 housed in the recesses 341 (see FIG. 4). The driving portion 81 of the driving member 8 may be housed in the housing portion 321 of the cylindrical portion 32. When the operating body 9 is in a non-operation state, a front end portion of the lever 82 of the driving member 8 may extend upward. The pressed portion 822 may be arranged at a position higher than upper ends of the support walls 34 (34a, 34b).

The torsion spring 12 (not shown in FIG. 5 or 6) may be arranged below the lever 82. The one arm 122a of the torsion spring 12 may be engaged at a surface of the recess 331, and the other arm 122b may be engaged at a lower surface of the lever 82. Accordingly, an urging force for urging the lever 82 upward may act on the driving member 8 around the shafts 821 as a rotation axis. The operating body 9 may be arranged above the pressed portion 822 of the lever 82. The operating body 9 may be arranged such that the recess 921 provided at the bottom surface 92 may house the pressed portion 822. The urging force of the torsion spring 12 acting on the driving member 8 may cause a force for moving the operating body 9 upward to constantly act on the operating body 9. Since the urging force of the torsion spring 12 acts when the pressed portion 822 provided at the driving member 8 directly supports the recess 921 provided at the operating body 9, the operating body 9 can be restored with a simple configuration without an additional member. Space utilization efficiency in the housing can be increased. Since the operating body 9 is housed in the housing portion 26 of the outer case 2 and hence a movable range of the operating body 9 is limited, the operating body 9 is not dropped from the pressed portion 822.

In the housing portion 321, the movable contacts 7 and the cam bodies 10 (10a, 10b) may be arranged at the lateral sides of the driving portion 81 of the driving member 8. The shafts 1012 of the cam bodies 10 may be housed in the recesses provided at the lower surfaces of the support portions 322a to 322d (not shown in FIG. 5, see, e.g., FIG. 6) from the lower side, and the shafts 1012 may be supported from the lower side by the support pieces 421a and 421b of the insulating cover 4 (not shown in FIG. 5, see, e.g., FIG. 7). Accordingly, the cam bodies 10 can rotate within a constant range around the shafts 1012 as rotation axes in the housing portion 321. The movable contacts 7 may hold the cam bodies 10 by the holders 72, and hence may be unitized with the cam bodies 10. Accordingly, the movable contacts 7 can also rotate within a constant range like the cam bodies 10.

The flat surfaces 521 of the holders 52 (52a, 52b) of the first terminals 5 may be arranged on flat surfaces 311a and 311b of the walls 31a and 31b. In this case, the flat surfaces 521 may be arranged such that the openings 521a may correspond to the insertion holes 313 (313a, 313b) and the outer arms 521b are inserted into the slits 314 (314a, 314b). Also, the holders 52 may be arranged such that the vertical surfaces 522 may extend along walls that are vertically arranged on rear end portions of the flat surfaces 311a and 311b. The inner bent portions 522a provided at the vertical surfaces 522 may be arranged to extend along inner wall surfaces that define the housing portion 321. The outer bent portions 522a may be inserted into the slits 325 formed at the cylindrical portion 32.

The fixing screws 11 may be inserted into through holes 313a and 313b from the lower side of the inner case 3, and may penetrate through the openings 521a of the holders 52. The cap pins 51 of the first terminals 5 may be fixed to the fixing screws 11 protruding from the openings 521a. When surfaces of the holders 52 are fixed, the lower surfaces of the fixing portions 513 of the cap pins 51 may be in contact with the conductive pieces 521c of the holders 52. Accordingly, the cap pins 51 and the holders 52 may be brought into conduction.

The second terminals 6 may be arranged such that the rear terminals 62 may extend along the inner wall surfaces that define the housing portion 321 and the front terminals 61 pass through the gaps between the walls 31 (31a, 31b) and the support walls 34a and 34b. Also, front end portions of the front terminals 61 may protrude to the lower side of the disk-like portion 33 through slits (not shown) formed at the disk-like portion 33.

As shown in FIG. 5, the insulating cover 4 may be fixed to the cylindrical portion 32 such that the openings 431 formed at the fixing portions 43 may house the protruding pieces 324 provided at the outer surface of the cylindrical portion 32. In this fixed state, upper ends of the support pieces 421a and 421b of the insulating cover 4 may be arranged at positions at which the upper ends support the shafts 1012 of the cam bodies 10 from the lower side (not shown in FIG. 5 or 6, see FIG. 7).

As shown in FIGS. 5 and 6, in the switch device 1, the housing portion 26 that houses the operating body 9 may be arranged in one region and the movable contacts 7 may be arranged in the other region with respect to the plane containing the extending directions of both the pair of first terminals 5 (the cap pins 51). Accordingly, the space in the housing (the inner case 3) can be efficiently used. The components can be efficiently housed in the housing, and working efficiency when the components are assembled can be increased. In particular, since the driving member 8 may be arranged to pass through the space between the pair of first terminals 5, the space utilization efficiency in the housing can be further increased. Further, since the operating body 9 may be arranged in the region different from the space between the pair of first terminals 5, even if a dent is present at a center portion of a socket of a fluorescent-lamp fixture to which the switch device 1 is attached, the operating body 9 can receive a pressing operation into the housing.

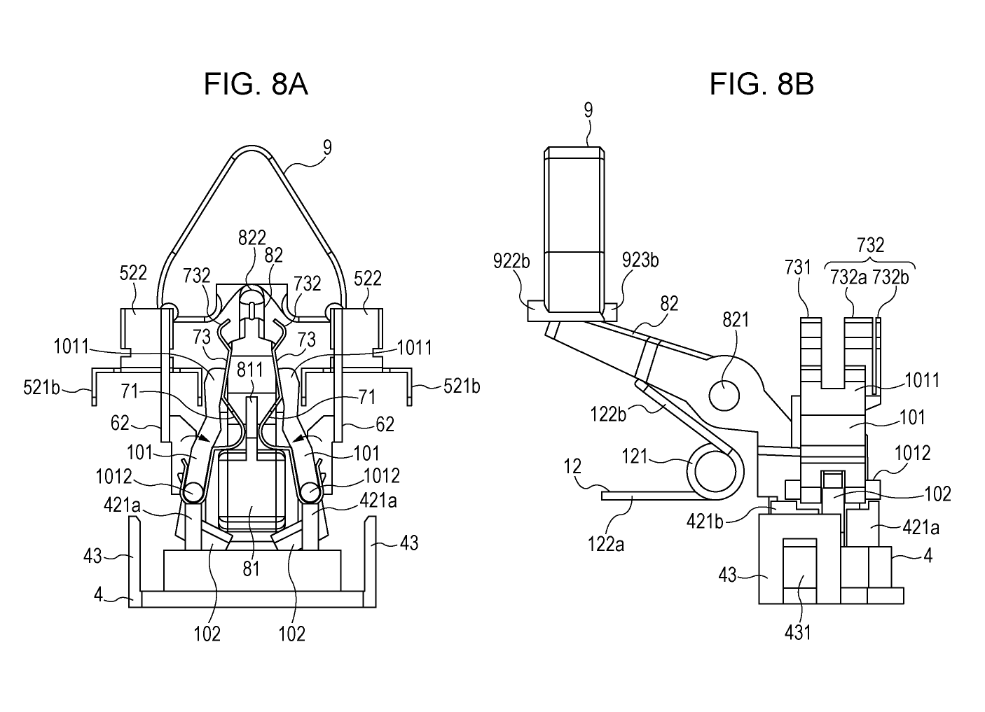

FIGS. 7, 8A, and 8B are explanatory views of a positional relationship among the components in the switch device 1. FIG. 7 is a perspective view of the positional relationship among the components in the switch device 1 when viewed from the rear side. FIGS. 8A and 8B provide a rear view and a side view each showing the positional relationship among the components in the switch device 1. FIGS. 7, 8A, and 8B show a case when the operating body 9 is in a non-operation state. Also, illustration of the first and second terminals 5 and 6 are omitted in FIG. 8B for convenience of the description.

When the operating body 9 is in the non-operation state, the driving member 8 may receive the urging force of the torsion spring 12, one end of the driving portion 81 may be arranged at the rear side is arranged near the insulating cover 4, and the other end of the driving portion 81 near the pressed portion 822 may be arranged at the front side extends upward (see FIG. 8B). In this state, a lower end portion of the driving portion 81 may come into contact with and pushes down the engagement pieces 102 of the cam bodies 10 (10a, 10b). Accordingly, forces that rotate the entire bases 101 inward (in directions indicated by arrows in FIG. 8A) may act on the cam bodies 10 around the shafts 1012 as the rotation axes.

The movable contacts 7 may be in a state in which the contacts 73 and the contact portions 1011 may be rotated inward, and lower surfaces of the arc-like bases 71 may be placed on an upper surface of the driving portion 81. At this time, the plate portion 811 provided at the upper surface of the driving portion 81 of the driving member 8 may be arranged between the bases 71 of the movable contacts 7 and may prevent the bases 71 from coming into contact with each other. The first movable contacts 731 may be arranged to face the first contacts formed of the bent portions 522a of the first terminals 5. The second movable contacts 732 may be arranged to face the second contacts formed of the rectangular portions 621 of the second terminals 6. When the driving portion 81 pushes down the engagement pieces 102, the first movable contacts 731 and the second movable contacts 732 may be separated from the first contacts of the first terminals 5 and the second contacts of the second terminals 6.

As shown in FIGS. 7, 8A, and 8B, in the switch device 1, the movable contacts 7 may be formed with members different from the first and second terminals 5 and 6. Accordingly, an insulation distance between the contact 73 of the movable contact 7 and corresponding one of the first contacts that are conducting with the first terminals 5 and integrally provided with the first terminals 5, and between the contact 73 of the movable contact 7 and corresponding one of the second contacts that are conducting with the second terminals 6 and integrally provided with the second terminals 6 can be ensured. The level of insulation performance can be increased and the level of safety can be increased.

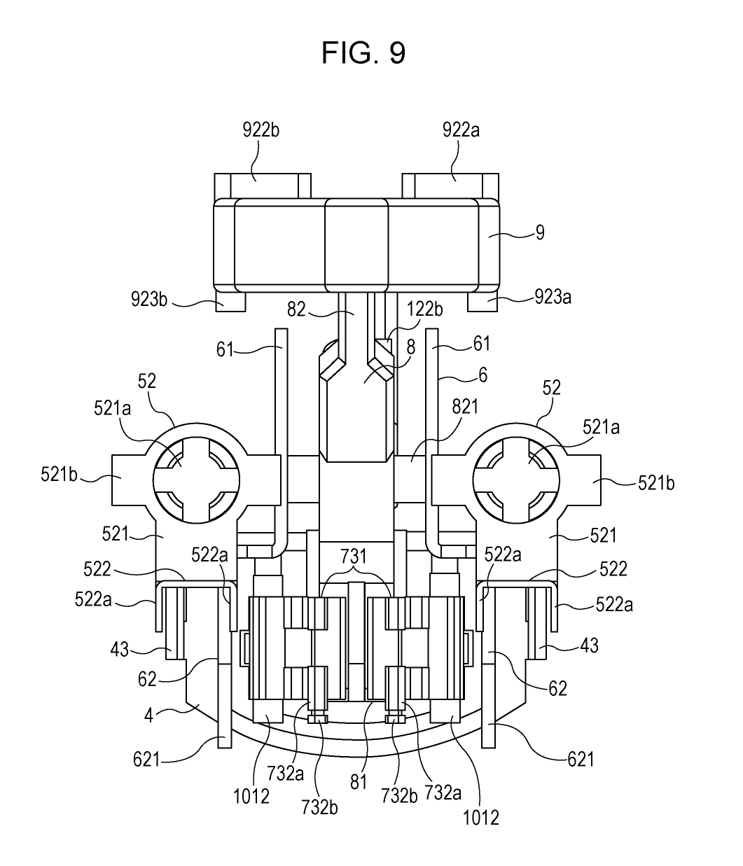

FIG. 9 is a top view for explaining the positional relationship among the components in the switch device 1 shown in FIG. 7. As shown in FIG. 9, when the components are attached to the inner case 3 (not shown), the inner bent portions 522a of the holders 52 that form the first contacts may be arranged at positions at the inner sides of the rectangular portions 621 of the second terminals 6 that form the second contacts. Also, the first movable contacts 731 facing the first contacts and the main contacts 732a of the second movable contacts 732 facing the second contacts may be arranged at the same positions in top view. The auxiliary contacts 732b of the second movable contacts 732 may be arranged at positions outside the main contacts 732a (i.e., positions near the second contacts).

When the cam bodies 10 rotate around the shafts 1012 as the rotation axes, the first movable contacts 731 of the contacts 73 of the movable contacts 7 may come into contact with the first contacts (the bent portions 522a). The auxiliary contacts 732b may come into contact with the second contacts (the rectangular portions 621), and then the main contacts 732a may come into contact with the second contacts (the rectangular portions 621). In the switch device 1, as described above, since the second movable contacts 732 may be divided and come into contact with the second contacts by a plural number of times at different timings, stability of contact occurring when the movable contacts 7 come into contact with the fixed contacts formed of the first and second contacts can be ensured.

In the following description, the switch device 1 that is attached to one end of the straight-tube LED lamp is described as an example for convenience of the description. However, the description for the switch device 1 that is attached to the other end of the straight-tube LED lamp may be similar to the switch device 1 attached to the one side.

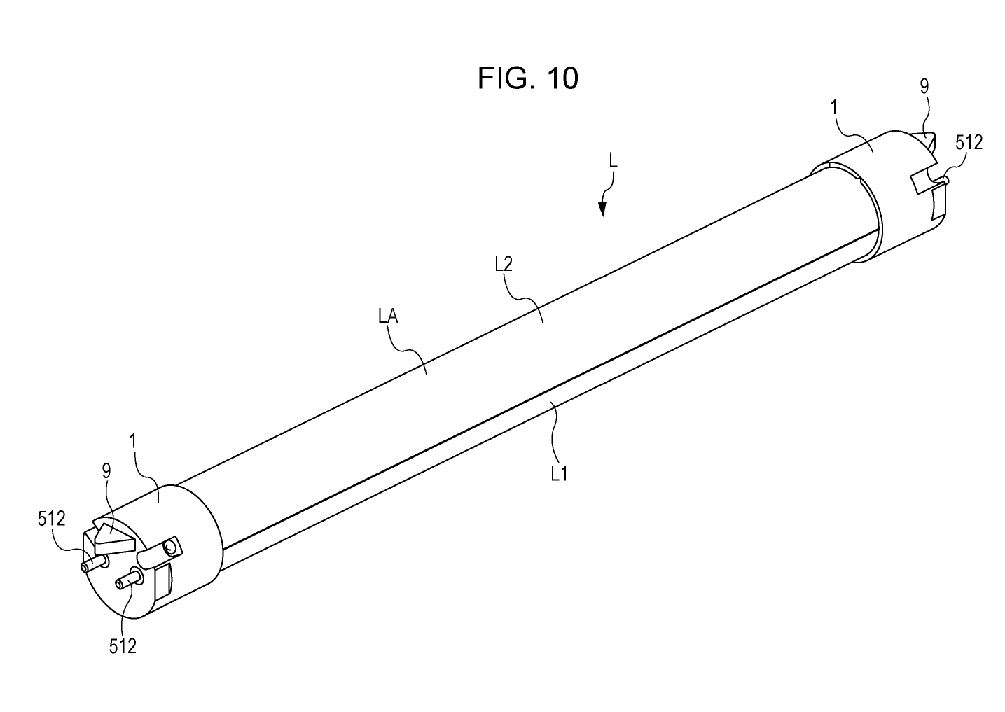

As shown in FIG. 10, a straight-tube LED lamp L may include a lamp body LA that may be molded into a cylindrical shape with an insulating resin material. At least an emission surface of the lamp body LA may have light transparency. The switch device 1 may be provided at each of both ends of the lamp body LA. The switch devices 1 may be attached to the lamp body LA such that the protruding positions of the operating bodies 9 may be arranged at the same position. A long substrate (not shown) may be housed in the lamp body LA. For example, a plurality of LEDs (not shown) and a driving circuit (not shown) connected with the LEDs may be mounted on the substrate. For example, the driving circuit may be formed of an AC/DC converter that converts an alternating voltage supplied through the first terminals 5 of the switch devices 1 to a direct voltage. When the straight-tube LED lamp L is attached to the fluorescent-lamp fixture through the switch devices 1, the alternating voltage applied through the first terminals 5 may be converted into the direct voltage by the AC/DC converter and is supplied to the LEDs. The LEDs emit light by the direct voltage fed from the AC/DC converter.

In the straight-tube LED lamp L, for example, the plurality of LEDs may be mounted on one surface of the substrate housed in the lamp body LA, and components other than the LEDs (for example, the AC/DC converter) may be mounted on the other surface. Hence, a portion of a peripheral surface of the lamp body LA corresponding to the one surface of the substrate with the LEDs mounted may form an emission surface L1, and a portion of the peripheral surface corresponding to the other surface of the substrate with the components other than the LEDs mounted may form a non-emission surface L2. For example, the components, such as a radiator plate, may be arranged in the portion of the lamp body LA corresponding to the non-emission surface L2. Also, the cylindrical lamp body LA may be configured such that the portion of the lamp body LA at the non-emission surface L2 side may be formed of a metal case made of a metal material, the portion of the lamp body LA at the emission surface L1 side may be formed of a light-transmissive resin case, and the metal case and the resin case may be unitized. In this case, the metal case may be used as a radiator plate.

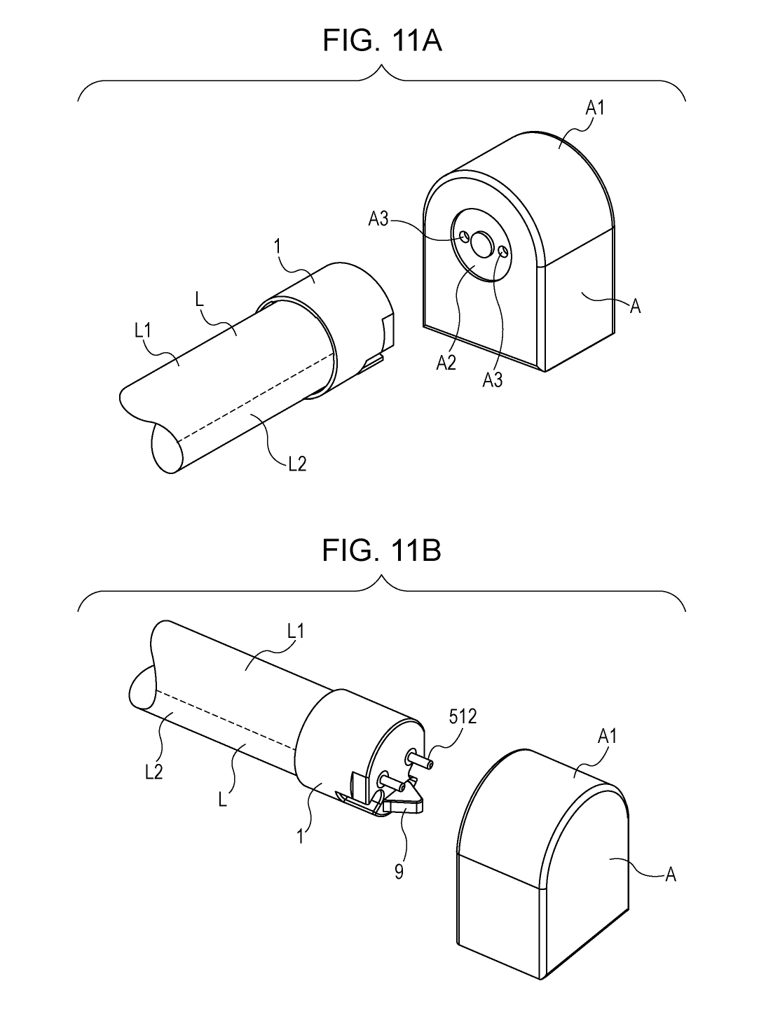

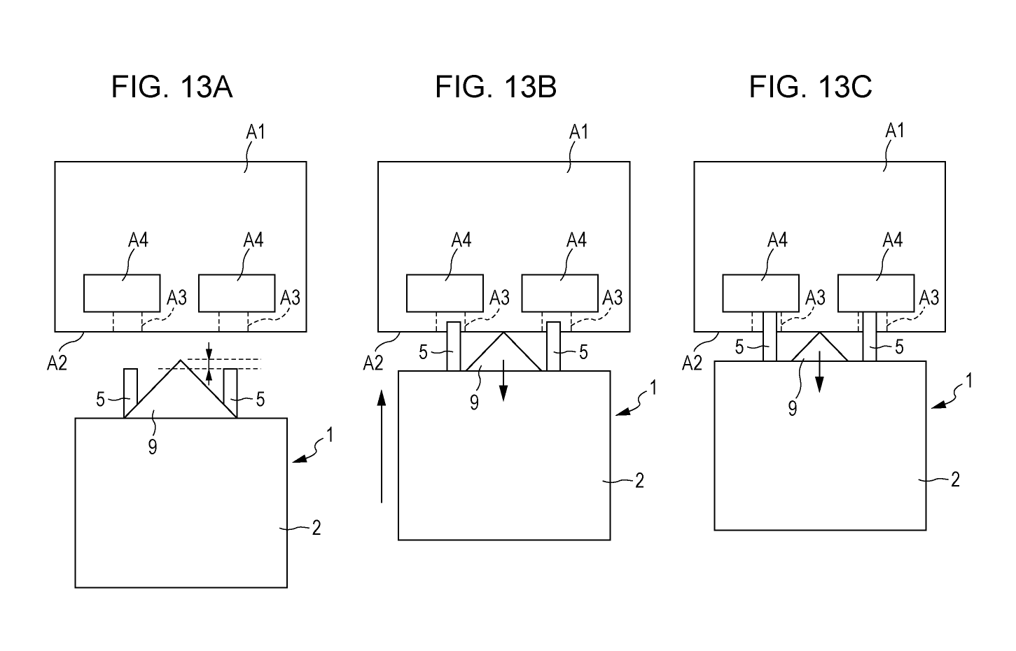

FIGS. 11A and 11B are perspective views showing a state of the switch device 1 immediately before attachment to the first-type fluorescent-lamp fixture A. FIGS. 11A and 11B each schematically show part of the straight-tube LED lamp L. The first-type fluorescent-lamp fixture A may include a socket A1 to which the switch device 1 of the straight-tube LED lamp L may be attached, a circular attachment surface A2 provided at a surface (side surface) of the socket A1, and a pair of cap-pin insertion holes A3 provided at the attachment surface A2. The pair of cap-pin insertion holes A3 may form holes. Electrodes A4 (not shown in FIG. 11A or 11B, see FIGS. 13A to 13C) may be provided at deep positions in the pair of cap-pin insertion holes A3. The electrodes A4 may be brought into conduction with the cap pins 51 (51a, 51b) of the first terminals 5.

When the straight-tube LED lamp L is attached, the cap pins 51 of the pair of first terminals 5 included in the switch device 1 may be positioned with respect to the cap-pin insertion holes A3 and then may be inserted into the cap-pin insertion holes A3, so that the connection portions 512 of the cap pins 51 may be connected with the electrodes A4. In the switch device 1, as the result of this insertion operation, the vertex portion 91 of the operating body 9 may come into contact with the attachment surface A2 of the socket A1 and may be pressed into the outer case 2 (the housing portion 26). In this case, the operating body 9 may be guided to the lower side (deep side) by the inner wall surfaces 26a and 26b of the housing portion 26. As described above, since the operating body 9 is guided by the inner wall surfaces 26a and 26b that are the guide portions provided at the housing portion 26, the operating body 9 can be smoothly housed in the housing portion 26 by the pressing operation in accordance with the insertion operation.

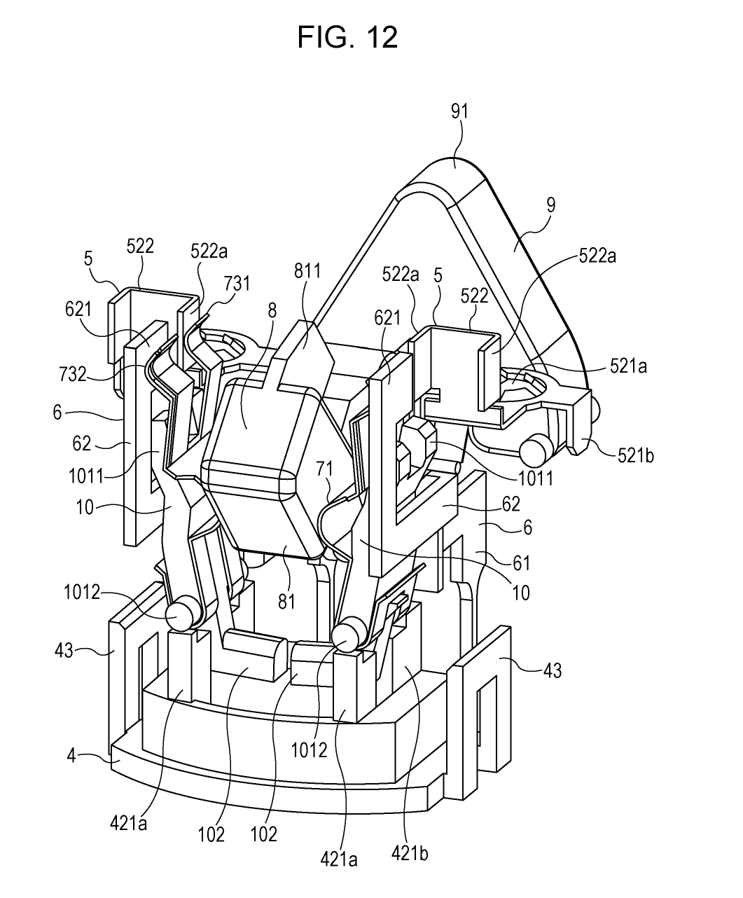

FIG. 12 is a perspective view showing a state of the components in the switch device 1 when the switch device 1 is attached to the first-type fluorescent-lamp fixture A. FIG. 12 only shows the components shown in FIG. 7 for convenience of the description. When the operating body 9 is pressed into the outer case 2 (the housing portion 26), as shown in FIG. 12, the pressed portion 822 of the lever 82 with the operating body 9 placed may be pushed downward. Accordingly, the lever 82 of the driving member 8 may be pushed down against the urging force of the torsion spring 12, and may rotate around the shafts 821 as the rotation axis.

By the rotation of the driving member 8, the driving portion 81 may move upward while the driving portion 81 pushes and expands the bases 71 (e.g., the protrusions) of the movable contacts 7. In this case, the movable contacts 7 may rotate around the shafts 1012 of the cam bodies 10 held by the movable contacts 7, as the rotation axes. When the bases 71 move from the upper surface to the side surfaces of the driving portion 81, the first movable contacts 731 and the second movable contacts 732 of the movable contacts 7 may come into contact with the first contacts and the second contacts (a state shown in FIG. 12). When the bases 71 come into contact with the side surfaces of the driving portion 81, the inward movement of the movable contacts 7 may be limited. When the first movable contacts 731 and the second movable contacts 732 come into contact with the first contacts and the second contacts, the first terminals 5 and the second terminals 6 may be brought into conduction, and a state may be changed to an ON state in which electricity can be applied to the driving circuit (the AC/DC converter) mounted on the straight-tube LED lamp.

In contrast, when the switch device 1 is removed from the first-type fluorescent-lamp fixture A, the pressing operation on the operating body 9 may be released. Hence, the pressed portion 822 of the lever 82 of the driving member 8 may be pushed upward by the urging force of the torsion spring 12, and the driving member 8 may rotate around the shafts 821 as the rotation axis. By the rotation of the driving member 8, the driving portion 81 may move downward to a position near the insulating cover 4 (a state shown in, for example, FIG. 7). In the course of the movement to the state in FIG. 7, the driving portion 81 may come into contact with and push down the engagement pieces 102 of the cam bodies 10. When the engagement pieces 102 move downward, the movable contacts 7 may rotate around the shafts 1012 of the cam bodies 10 as the rotation axes. Accordingly, the contact portions 1011 of the cam bodies 10 may press the contacts 73 of the movable contacts 7 inward. When the limitation for the inward movement of the movable contacts 7 by the side surfaces of the driving portion 81 is released, the movable contacts 7 may become able to move inward. When the movable contacts 7 move, the first movable contacts 731 and the second movable contacts 732 may become separated from the first contacts and the second contacts. When the first movable contacts 731 and the second movable contacts 732 are separated from the first contacts and the second contacts, the first terminals 5 and the second terminals 6 may be brought out of conduction, and a state may be changed to an OFF state in which electricity is not applied to the driving circuit mounted on the straight-tube LED lamp.

Also, in the switch device 1, when the pressing operation on the operating body 9 is released and the driving member 8 is restored to the initial state (the state shown in FIG. 7), the contact portions 1011 of the cam bodies 10 may restore (press) the contacts 73 inward. Accordingly, the first movable contacts 731 and the second movable contacts 732 can be reliably separated from the first contacts of the first terminals 5 and the second contacts of the second terminals 6. As the result, the conduction state between the first terminals 5 and the second terminals 6 can be properly changed in accordance with the pressing operation on the operating body 9.

In particular, in the switch device 1, the cam bodies 10 may be arranged between the contacts 73 of the movable contacts 7, and the first contacts (the first terminals 5) and the second contacts (the second terminals 6), and when the engagement pieces 102 are pressed by the driving member 8, the contacts 73 of the movable contacts 7 may be rotated in a direction away from the first contacts and the second contacts. Accordingly, when the operating body 9 is restored to the initial position and the engagement pieces 102 are pressed by the driving member 8, the contacts 73 of the movable contacts 7 may be pressed in the direction away from the first contacts and the second contacts. The first terminals 5 and the second terminals 6 can be reliably brought into an insulating state.

FIGS. 13A to 13C are schematic illustrations for explaining the relationship between the first terminals 5 and the operating body 9 when the straight-tube LED lamp L according to this embodiment is attached to the first-type fluorescent-lamp fixture A. FIGS. 13A to 13C are illustrations when a connection portion between the socket A1 of the first-type fluorescent-lamp fixture A and the switch device 1 is viewed from a direction orthogonal to the protruding direction of the operating body 9.

FIG. 13A shows a state in which the operating body 9 is separated from the attachment surface A2 of the socket A1. As shown in FIG. 13A, in the state in which the operating body 9 is separated from the attachment surface A2 (i.e., in the initial state of the operating body 9), the distal end portion (the vertex portion 91) of the operating body 9 may be arranged at a position outside distal end portions of the first terminals (the cap pins 51). That is, the position of the distal end portion of the operating body 9 in the initial state may protrude to the front side (upper side in FIGS. 13A to 13C) in the protruding directions of the first terminals 5 with respect to the positions of the distal end portions of the first terminals 5.

When the switch device 1 is moved toward the socket A1, the distal end portion (the vertex portion 91) of the operating body 9 may come into contact with the attachment surface A2 of the socket A1. Hence, the operating body 9 is pressed into the housing (the outer case 2). When the operating body 9 is pressed into the housing (the outer case 2), as described above, the pressed portion 822 of the lever 82 is pushed downward. Hence, the lever 82 of the driving member 8 may be pushed downward against the urging force of the torsion spring 12, and may rotate around the shafts 821 as the rotation axis. When the lever 82 is pushed downward to a certain position or farther, the contacts 73 of the movable contacts 7 may come into contact with the fixed contacts formed of the first contacts and the second contacts. Accordingly, the first terminals 5 and the second terminals 6 may be brought into conduction, and a state may be changed to an ON state in which electricity can be applied to the driving circuit (the AC/DC converter) mounted on the straight-tube LED lamp L.

FIG. 13B shows a state of the first terminals 5 and the operating body 9 when the first terminals 5 and the second terminals 6 are brought into conduction. As shown in FIG. 13B, when the first terminals 5 and the second terminals 6 are brought into conduction, the distal end portions of the first terminals 5 (the cap pins 51) may be housed in the cap-pin insertion holes A3. At this time, the distal end portions of the first terminals 5 (the cap pins 51) are not in contact with exposed surfaces (lower surfaces in FIGS. 13A to 13C) of the electrodes A4.

When the switch device 1 is further moved toward the socket A1 from the state shown in FIG. 13B, as shown in FIG. 13C, the operating body 9 may be pressed into the housing (the outer case 2) and the distal end portions of the first terminals 5 (the cap pins 51) may come into contact with the exposed surfaces of the electrodes A4. Since the distal end portions of the first terminals 5 that are in conduction with the second terminals 6 come into contact with the electrodes A4, electricity may be applied to the driving circuit (the AC/DC converter) mounted in the straight-tube LED lamp L.

As described above, in the switch device 1, the operating body 9 may be pressed into the housing (the outer case 2) by the attachment surface A2 of the socket A1 before the first terminals 5 (the connection portions 512 of the cap pins 51) comes into contact with the electrodes A4. The first terminals 5 and the second terminals 6 may be brought into conduction. Accordingly, arc discharge may be prevented from occurring at the switch device 1. Hence, an expensive material dealing with arc discharge (for example, a silver chip) does not have to be used for a material of a contact (for example, a contact such as the movable contact 7) that changes the conduction state between the first terminals 5 and the second terminals 6. An increase in cost can be restricted. Also, since arc discharge can be prevented from occurring in the switch device 1, a defect of components in the switch device 1 as the result of arc discharge (for example, welding between the contacts 73 of the movable contacts 7 and the fixed contacts (the first contacts and the second contacts)) can be reliably prevented from occurring. Consequently, a situation in which an application state of electricity to a plurality of LEDs cannot be changed due to the occurrence of a defect such as welding can be reliably prevented from occurring.

In particular, in the switch device 1, the distal end portions of the first terminals 5 (the cap pins 51) may be housed in the cap-pin insertion holes A3 provided at the socket A1 at the time when the first terminals 5 and the second terminals 6 are brought into conduction. Accordingly, when the straight-tube LED lamp L is attached, a worker hardly contacts the first terminals 5. Safety during the work can be ensured. In the above description, safety during the attachment work of the straight-tube LED lamp L with respect to the socket A1 is described. However, safety can be ensured similarly when the straight-type LED lamp L is removed.

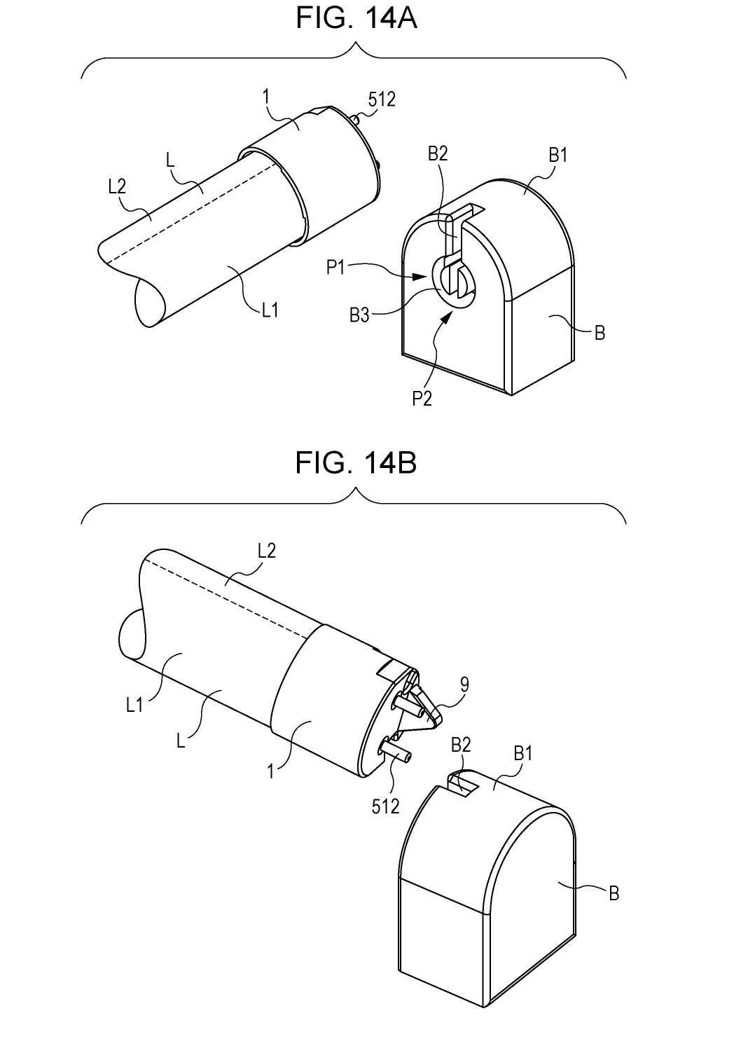

FIGS. 14A and 14B are perspective views showing a state of the switch device 1 immediately before attachment to the second-type fluorescent-lamp fixture B. The second-type fluorescent-lamp fixture B may include a socket B1 to which the switch device 1 is attached, and may have a first groove B2 that may be formed in a linear shape in the up-down direction at an attachment surface of the socket B1 and a second groove B3 that may be formed in a circular shape at a position near a lower end of the first groove B2 in FIG. 14A. Connected terminals (not shown) may be provided inside the second groove B3. The connected terminals may be brought into conduction with the cap pins 51 (51a, 51b) of the first terminals 5.

When the straight-tube LED lamp L is attached, the connection portions 512 of the cap pins 51 of the pair of first terminals 5 of the switch device 1 may be positioned to extend along an extending direction of the first groove B2, and the pair of cap pins 51 (the connection portions 512) may be inserted along the first groove B2. When the cap pin 51 at the lower side reaches a lower end portion of the first groove B2, the switch device 1 may be rotated along the second groove B3, and the connection portions 512 of the cap pins 51 may be connected with the connected terminals. In the switch device 1, the second pressed portion 94 (the first pressed portion 93) of the operating body 9 may come into contact with the attachment surface of the socket B1 by the insertion operation on the first groove B2. Accordingly, the operating body 9 may be tilted and pushed into the outer case 2 (the housing portion 26). In this case, the operating body 9 may be guided to the lower side (to a deep side of the housing portion 26) by the inner wall surfaces 26a and 26b of the housing portion 26.

As shown in FIGS. 10, 14A, and 14B, in the switch device 1, the operating body 9 may be provided in a region at a non-emission surface side (L2 side) of a lamp body LA. Hence, when the attachment of the straight-tube LED lamp L (e.g., the switch device 1) to the socket B1 is completed, the operating portion of the operating body 9 does not enter the first groove B2. That is, when the pair of cap pins 51 is inserted along the first groove B2 to the deep position, the operating body 9 may come into contact with a portion indicated by arrow P1 in FIG. 14A. In the attachment completion state in which the straight-tube LED lamp L (the switch device 1) is rotated along the second groove B3 by 90 degrees, the operating body 9 may come into contact with the socket B1 at a portion indicated by arrow P2 in the same drawing, so that the pushed operating body 9 is not restored.

In the switch device 1, since the operating body 9 may include the first pressed portion 93 that receives a pressing operation from one side and the second pressed portion 94 that receives a pressing operation from the other side, the one side and the other side being opposite to each other with respect to the protruding directions of the first terminals 5 (the cap pins 51), the operating body 9 can be tilted and pushed into the housing portion 26 in accordance with the pressing operation on the first or second pressed portion 93 or 94 with a simple configuration. In particular, in the switch device 1, since the operating body 9 may be movable along the plane containing the protruding directions of both the pair of first terminals 5 (the cap pins 51), the straight-tube LED lamp L can be easily attached to the second-type fluorescent-lamp fixture B.

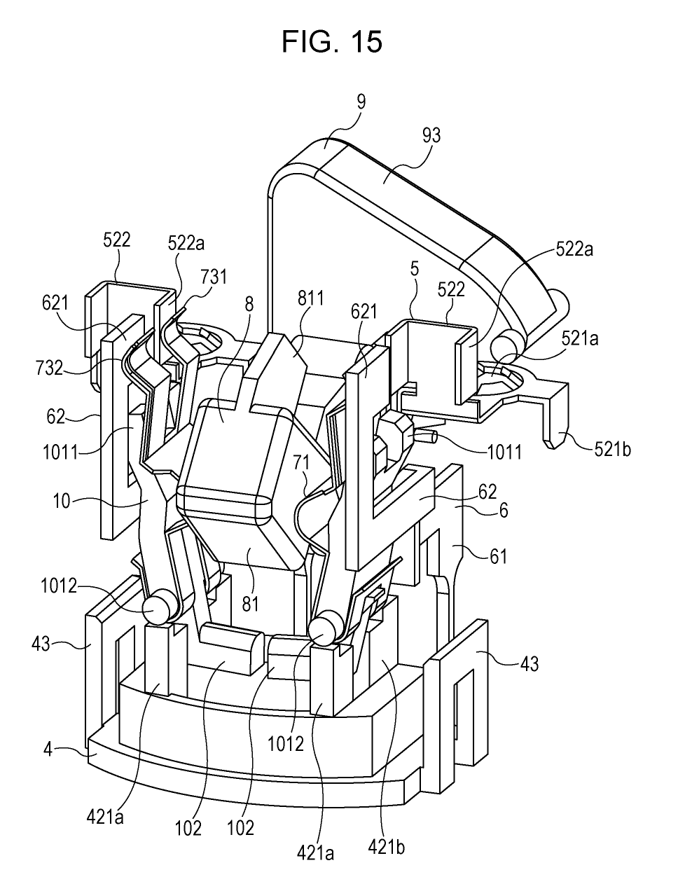

FIG. 15 is a perspective view showing a state of the components in the switch device 1 when the switch device 1 is attached to the second-type fluorescent-lamp fixture B. FIG. 15 only shows the components shown in FIG. 7 for convenience of the description. When the operating body 9 is pressed into the outer case 2 (the housing portion 26), as shown in FIG. 15, the pressed portion 822 of the lever 82 with the operating body 9 placed may be pushed downward. Accordingly, the lever 82 of the driving member 8 may be pushed down against the urging force of the torsion spring 12, and the driving member 8 may rotate around the shafts 821 as the rotation axis.

By the rotation of the driving member 8, the driving portion 81 may move upward while the driving portion 81 may push and expand the bases 71 (the protrusions) of the movable contacts 7. In this case, the movable contacts 7 may rotate around the shafts 1012 of the cam bodies 10 held by the movable contacts 7, as the rotation axes. When the bases 71 move from the upper surface to the side surfaces of the driving portion 81, the first movable contacts 731 and the second movable contacts 732 may come into contact with the first contacts and the second contacts (a state shown in FIG. 15). When the bases 71 come into contact with the side surfaces of the driving portion 81, the inward movement of the movable contacts 7 may be limited. When the first movable contacts 731 and the second movable contacts 732 come into contact with the first contacts and the second contacts, the first terminals 5 and the second terminals 6 may be brought into conduction, and a state may be changed to an ON state in which electricity can be applied to the driving circuit mounted on the straight-tube LED lamp.

When the operating body 9 moves to the state shown in FIG. 15, by the pressing operation from the lateral sides, the operating body 9 may be tilted, one of the first pressed portion 93 and the second pressed portion 94 may come into contact with the inner wall surface 26a or the inner wall surface 26b that is the guide portion of the housing portion 26, and then may be pushed into the housing portion 26. To perform the pushing operation into the housing portion 26 after the tilting, the switch device 1 may be configured such that, in a state in which a pressed portion (an inclination portion) of one of the first pressed portion 93 (the first inclination portion 93a) and the second pressed portion 94 (the second inclination portion 94a) may come into contact with the inner wall surface 26a or the inner wall surface 26b of the housing portion 26 by the tilting, the other pressed portion (the inclination portion) protrudes from the opening 23. Accordingly, the pushing operation after the tilting can be reliably performed. The conduction between the first terminals 5 and the second terminals 6 can be ensured.

In contrast, when the switch device 1 is removed from the second-type fluorescent-lamp fixture B, the pressing operation on the operating body 9 may be released. The pressed portion 822 of the lever 82 of the driving member 8 may be pushed upward by the urging force of the torsion spring 12, and the driving member 8 may rotate around the shafts 821 as the rotation axis. By the rotation of the driving member 8, the driving portion 81 may move downward to a position near the insulating cover 4 (the state shown in FIG. 7). In the course of the movement to the state in FIG. 7, the driving portion 81 may come into contact with and may push down the engagement pieces 102 of the cam bodies 10. When the engagement pieces 102 move downward, the movable contacts 7 may rotate around the shafts 1012 of the cam bodies 10 as the rotation axes. Accordingly, the contact portions 1011 of the cam bodies 10 may press the contacts 73 of the movable contacts 7 inward. When the limitation for the inward movement of the movable contacts 7 by the side surfaces of the driving portion 81 is released, the movable contacts 7 may become moveable inward. By the movement of the movable contacts 7, the first movable contacts 731 and the second movable contacts 732 may become separated from the first contacts and the second contacts. When the first movable contacts 731 and the second movable contacts 732 are separated from the first contacts and the second contacts, the first terminals 5 and the second terminals 6 may be brought out of conduction, and a state may be changed to an OFF state in which electricity is not applied to the driving circuit mounted on the straight-tube LED lamp.

Even if the switch device 1 is removed from the second-type fluorescent-lamp fixture B, when the driving member 8 is restored to the initial state (the state shown in FIG. 7), the contacts 73 may be restored inward by the contact portions 1011 of the cam bodies 10. Accordingly, the first terminals 5 and the second terminals 6 can be reliably brought out of conduction.

The relationship between the first terminals 5 (the cap pins 51) and the operating body 9 when the straight-tube LED lamp L is attached to the second-type fluorescent-lamp fixture B is similar to that when the straight-tube LED lamp L is attached to the first-type fluorescent-lamp fixture A, and hence the detailed description is omitted. In other words, even if the straight-tube LED lamp L is attached to the second-type fluorescent-lamp fixture B, the operating body 9 may be pressed into the housing (the outer case 2) before the first terminals 5 come into contact with the connected terminals corresponding to the electrodes A4, and the first terminals 5 and the second terminals 6 are brought into conduction.

As described above, in the switch device 1, since the position of the distal end portion of the operating body 9 in the initial state may protrude outside of the positions of the distal end portions of the first terminals 5, the operating body 9 can come into contact with the socket A1 (B1) before the first terminals 5. Accordingly, the operating body 9 can receive the pressing operation into the housing regardless of the positions of the electrodes A4 (the connected terminals) in the socket A1 (B1). By the pressing operation, the first terminals 5 and the second terminals 6 can be brought into conduction. Even if the positions of the electrodes A4 and the like vary in the socket A1 (B1), a state can be reliably changed to an ON state in which electricity can be applied to the driving circuit that causes the LED to emit light.

Also, in the switch device 1 according to this embodiment, the operating body 9 is tilted by the pressing operation into the housing (the outer case 2) and the pressing operation from the one side or the other side that are opposite to each other with respect to the protruding directions of the first terminals 5 (the cap pins 51). Hence, at least part of the operating body 9 is housed in the housing, and the first terminals 5 are brought into conduction with the second terminals 6. Accordingly, even when the switch device 1 is attached to a fluorescent-lamp fixture of any of a type configured such that a terminal at one end of a straight-tube fluorescent lamp is inserted into one socket and then a terminal at the other end is inserted into the other socket and a type configured such that both terminals are simultaneously attached to sockets, the operating body 9 can be housed in the housing portion 26 and the first terminals 5 can be brought into conduction with the second terminals 6. The switch device 1 can be attached to any type of the fluorescent-lamp fixture.

In particular, in the switch device 1, the operating body 9 may be tilted by the pressing operation from both the one side and the other side that are opposite to each other with respect to the protruding directions of the first terminals 5, limitation for an attachment direction to a fluorescent-lamp fixture can be eliminated. Attachment work of a straight-tube LED lamp to a fluorescent-lamp fixture can be simplified.

### Second Embodiment

A switch device 200 according to an exemplary embodiment differs from the switch device 1 for example, in configurations of second terminals 240, a driving member 250, and a movable contact unit 260. The configuration of the switch device 200 is described mainly for points different from the first embodiment. In the switch device 200, like reference signs refer like components having functions common to those of the switch device 1 according to the first embodiment, and the description thereof is omitted.

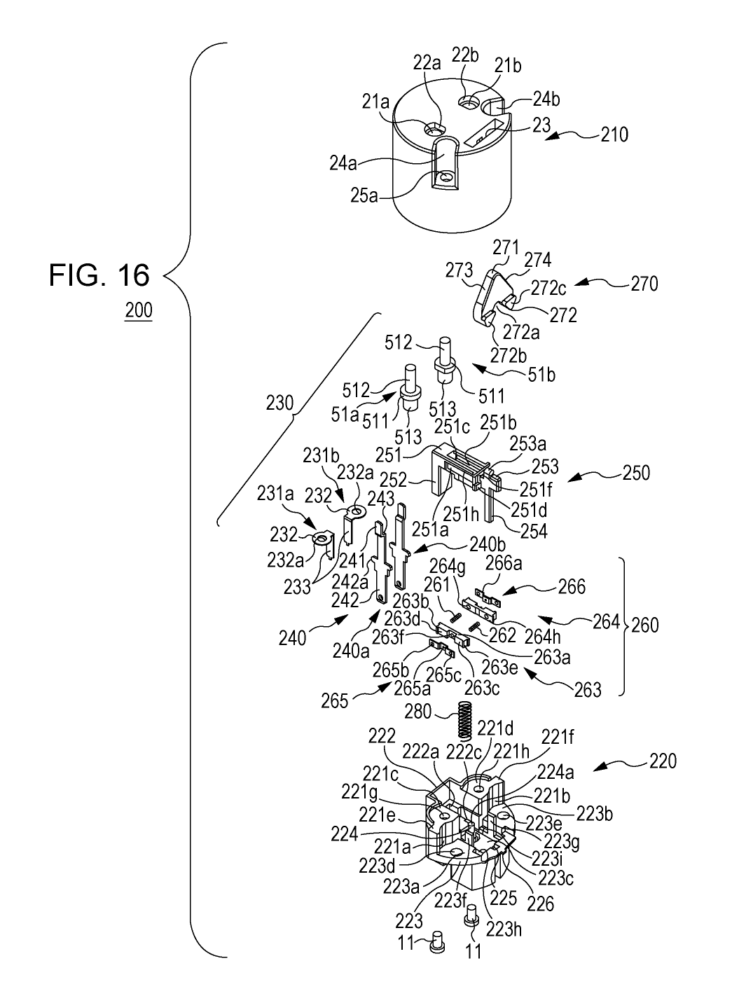

FIG. 16 is an exploded perspective view showing a general configuration of the switch device 200. In the following description, the upper left side in FIG. 16 is referred to as the “rear side of switch device 200” or merely “rear side,” and the lower right side in FIG. 16 is referred to as the “front side of switch device 200” or merely “front side.”

As shown in FIG. 16, the switch device 200 may include an outer case 210 that may form a housing of a device body and an inner case 220; and first terminals 230 and the second terminals 240 that are attached to the inner case 220. Components, such as a driving member 250 with the movable contact unit 260 attached and an operating body 270, may be housed in an inner space that is formed when the outer case 210 is assembled with the inner case 220. The outer case 210 that forms the housing and the inner case 220; and the driving member 250 and the operating body 270 that are housed in the inner space may be molded with, for example, an insulating resin material.

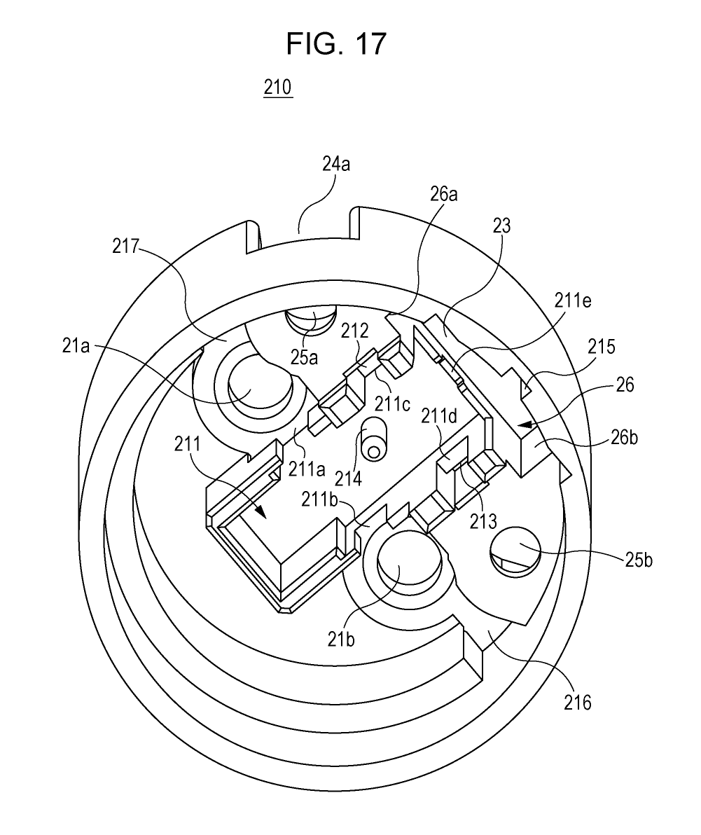

The outer case 210 may be configured substantially similarly to the outer case 2 in the switch device 1, particularly for an appearance and a housing portion 26 (not shown in FIG. 16, see FIG. 17) formed in an opening 23. However, a configuration of a lower surface (a back surface of an upper surface portion) of the outer case 210 differs from that of the switch device 1. FIG. 17 is a perspective view showing the outer case 210 when viewed from the obliquely lower side. As shown in FIG. 17, a housing portion 211 may be provided at a center portion of the lower surface of the outer case 210. The housing portion 211 may have a substantially rectangular shape in bottom view. Sides in the longitudinal direction of the housing portion 211 may extend in the front-rear direction of the outer case 210.

A wall surface portion that defines the housing portion 211 may have rectangular notches 211a, 211b, 211c, 211d, and 211e. Upper end portions of strip-like terminals 233 of contacts 231 (231a, 231b) of the first terminals 230 (described later) may be inserted into the pair of notches 211a and 211b. A groove 212 may be provided outside the housing portion 211 at a position facing the notch 211c. The groove 212 may have a predetermined depth from the lower surface of the outer case 210 to the upper side.

Also, a groove 213 may be provided outside the housing portion 211 at a position facing the notch 211d. The groove 213 may have a predetermined depth from the lower surface of the outer case 210 to the upper side. Distal end portions 241 of the second terminals 240 (as described below, for example) may be inserted into the grooves 212 and 213. An upper end portion at the rear side of a plate portion 253 of the driving member 250 (as described below, for example) may be inserted into the notch 211e.

A substantially columnar pin 214 may be provided in the housing portion 211. The pin 214 may extend from the lower surface of the outer case 210 that forms a ceiling surface of the housing portion 211, to the lower side by a predetermined length. The pin 214 may be inserted into an opening 251c and an insertion hole 251h of the driving member 250 (as described below, for example), and may be inserted into an upper portion of a coil spring 280 (as described below, for example).

A groove 215 may be provided at an inner wall surface of a cylindrical outer peripheral surface of the outer case 210 at a position in a front portion of the switch device 200. The groove 215 may extend in the up-down direction. Also, a pair of recesses 216 and 217 may be provided at lateral sides of through holes 21a and 21b. The recesses 216 and 217 may extend along the inner wall surface of the cylindrical outer peripheral surface of the outer case 210. The pair of recesses 216 and 217 may be defined by side walls formed at the lower surface of the outer case 210 by providing recesses 24a and 24b at a surface of the cylindrical outer peripheral surface, and by the inner wall surface of the cylindrical outer peripheral surface.

The inner case 220 may have a substantially circular shape in top view. The inner case 220 may have an outer diameter corresponding to a circumference shape of the outer case 210. A pair of walls 221 (221a, 221b) extending in the up-down direction may be provided at the center of the inner case 220. The walls 221a and 221b may be arranged side-by-side at a constant distance provided therebetween in the left-right direction of the switch device 200. A box-like portion 222 having a substantially rectangular-parallelepiped shape may be provided at a portion of the inner case 220 at the rear side with respect to the walls 221a and 221b. A disk-like portion 223 may be provided at a front portion of the inner case 220. The disk-like portion 223 having a substantially semicircular shape may extend from lower portions of the walls 221.

A flat surface 221c may be provided at an upper surface of the wall 221a. The flat surface 221c may have a substantially sector-like shape, and may have a protrusion 221e configured such that part of an outer periphery of the arc-like shape may protrude outward. Similarly, a flat surface 221d having a protrusion 221f may be provided at an upper surface of the wall 221b. The flat surface 221d may have a substantially sector-like shape. The protrusion 221f may be configured such that part of an outer periphery of the arc-like shape may protrude outward. When the inner case 220 may be assembled in the outer case 210, the protrusions 221e and 221f can be engaged with the recesses 216 and 217 provided at the lower surface of the outer case 210. Also, insertion holes 221g and 221h may be formed near the centers of the flat surfaces 221c and 221d. Fixing screws 11 may be inserted into the insertion holes 221g and 221h.

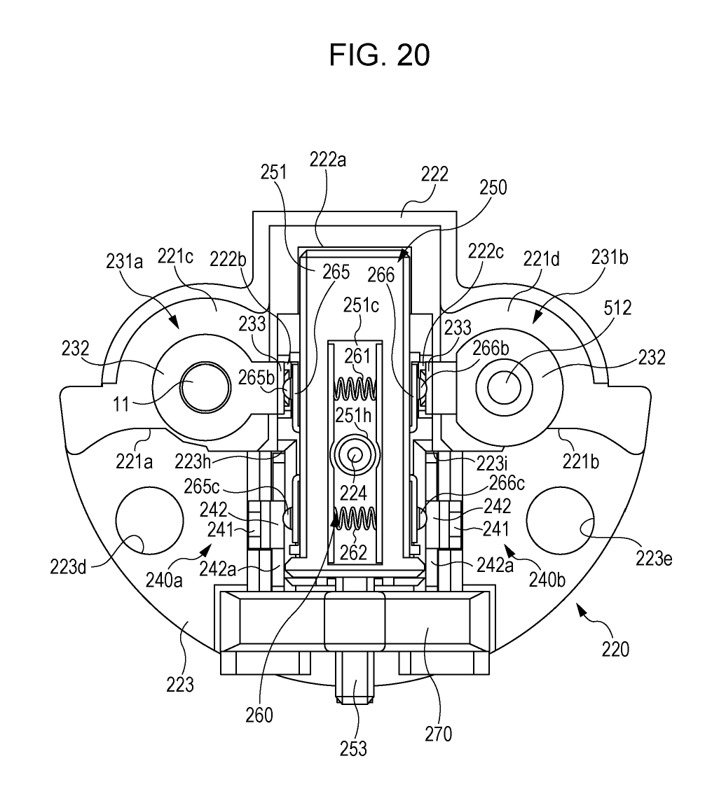

A housing portion 222a having a substantially rectangular shape in top view may be provided in the box-like portion 222 (see FIG. 20). The housing portion 222a provided in the box-like portion 222 may extend in the up-down direction. Although the detail is described later, the housing portion 222a may house part of a guided portion 252 of the driving member 250. Also, slits 222b and 222c each having a predetermined depth may be provided near lower end portions of a pair of facing inner wall surfaces from among inner wall surfaces that define the box-like portion 222 (the slit 222b is not shown in FIG. 16, see FIG. 20). Part of the contacts 231a and 231b of the first terminals 230 (as described below, for example) may be inserted into the slits 222b and 222c.

The disk-like portion 223 may include a pair of flat surfaces 223a and 223b, and a flat surface 223c positioned between the flat surfaces 223a and 223b. Upper surfaces of the flat surfaces 223a and 223b may be located in the same plane, and an upper surface of the flat surface 223c may be arranged at a position lower than that plane. Each of the pair of flat surfaces 223a and 223b may have a substantially sector-like shape. The flat surfaces 223a and 223b may have a pair of through holes 223d and 223e at predetermined positions. The through holes 223d and 223e may be used when the switch device 200 is fixed to a lamp body by fixing members such as screws (not shown). A pin 224 may be provided at the flat surface 223c at a position near the boundary between the flat surface 223c and the box-like portion 222, at equivalent distances from the pair of walls 221a and 221b.

The pin 224 may extend from the upper surface of the flat surface 223c to the upper side by a predetermined length. The pin 224 may support a lower end portion of the coil spring 280 (as described below, for example) and may restrict movement of the coil spring 280. A circular recess 224a may be formed around the pin 224. The recess 224a may have an outer diameter slightly larger than an outer diameter of the pin 224. Hence, a bottom wall may be provided around the pin 224 in the recess 224a. The lower end portion of the coil spring 280 (as described below, for example) may come into contact with the bottom wall.

Also, prisms 223f and 223g may be provided near the boundary between the flat surface 223a and the flat surface 223c, and near the boundary between the flat surface 223b and the flat surface 223c. A slit 223h may be formed between the prism 223f and the flat surface 223c. Similarly, a slit 223i may be formed between the prism 223g and the flat surface 223c. Part of the second terminals 240 (as described below, for example) may be inserted into the slits 223h and 223i (see FIG. 20).

A recess 225 may be provided at the front side of the flat surface 223c. The recess 225 may house a guided portion 254 of the driving member 250 (as described below, for example). The recess 225 may extend downward and may be in a slit form. Also, a protruding piece 226 may be provided at a front end of the disk-like portion 223. The protruding piece 226 may protrude slightly forward from a side surface at the front end. When the inner case 220 is assembled in the outer case 210, the protruding piece 226 may be arranged in the groove 215 of the outer case 210.

The first terminals 230 each may include a pair of cap pins 51 (51a, 51b) and the contacts 231 (231a, 231b). The cap pins 51 may have substantially the same configuration as that of the cap pins in the switch device 1. The contacts 231 may be formed by punching and bending conductive metal plates. The contacts 231 each may include a flat surface 232 having a substantially circular shape, and the strip-like terminal 233 may be formed by bending the contact 231 from the flat surface 232 perpendicularly downward. A circular opening 232a may be formed at the center of the flat surface 232.

The second terminals 240 (240a, 240b) may be formed by punching and bending conductive metal plates. The second terminals 240 (240a, 240b) each may include the distal end portion 241 and a strip-like terminal 242 that may be arranged in parallel to each other, and a coupling portion 243 that may couple the distal end portion 241 with the strip-like terminal 242. The distal end portion 241 and the strip-like terminal 242 may extend in the up-down direction of the switch device 200. The coupling portion 243 may be arranged orthogonally to the distal end portion 241 and the strip-like terminal 242. The distal end portion 241 may continuously extend from one end portion of the coupling portion 243, and more particularly from an upper surface of an outer portion of the coupling portion 243. The strip-like terminal 242 may continuously extend from the other end portion of the coupling portion 243, and more particularly from a lower surface of an inner portion of the coupling portion 243. Protruding pieces 242a may be formed near the centers in the up-down direction of the strip-like terminals 242. Each of the protruding pieces 242a may protrude in a step form in the same plane as the plane of the strip-like terminal 242.

When the inner case 220 with such second terminals 240 fixed may be assembled in the outer case 210, upper portions of the strip-like terminals 242 of the second terminals 240 may be inserted into the pair of notches 211c and 211d formed at the outer case 210. The second terminals 240 may be inserted to positions at which the protruding pieces 242a may come into contact with the lower surface of the wall surface portion of the housing portion 211. When the second terminals 240 are inserted to the positions at which the protruding pieces 242a come into contact with the lower surface of the wall surface portion of the housing portion 211, upper surfaces of the coupling portions 243 may come into contact with upper ends of the pair of notches 211c and 211d and the distal end portions 241 are inserted into the grooves 212 and 213.

In the switch device 200 according to this embodiment, the strip-like terminals 233 of the first terminals 230 may form first contacts and the strip-like terminals 242 of the second terminals 240 may form second contacts. The first and second contacts may form fixed contacts. Part of the movable contact unit 260 (in particular, contacts 265b, 265c, 266b, and 266c) may come into contact with and is separated from the fixed contacts.

The driving member 250 may include a contact holder 251 having a substantially rectangular-parallelepiped shape, the guided portion 252 extending downward from a rear end portion of the contact holder 251, the plate portion 253 protruding forward from a center portion of a front surface of the contact holder 251, and the guided portion 254 extending downward from a lower surface of the plate portion 253. The guided portions 252 and 254 may have substantially rectangular-parallelepiped shapes. The guided portion 252 may have the same width as a width of the driving member 250. The guided portion 254 may have the same width as a width of the plate portion 253.

A pair of openings 251a and 251b may be formed at side surfaces of the contact holder 251. Also, the opening 251c may be formed at the upper surface of the contact holder 251. The openings 251a, 251b, and 251c may have rectangular shapes, and extend from positions near a front end of the contact holder 251 to predetermined positions at the rear side. A portion of the contact holder 251 with the openings 251a to 251c may have a hollow structure.

A pair of pressed pieces 251d and 251e (the pressed piece 251e is not shown in FIG. 16) may be provided at a lower side of a front surface portion of the contact holder 251, with the plate portion 253 interposed therebetween. The pressed pieces 251d and 251e each may have a substantially rectangular shape and may protrude slightly forward. Also, slits 251f and 251g (the slit 251g is not shown in FIG. 16) may be formed at the front surface of the contact holder 251. The slits 251f and 251g may extend upward from upper end portions of the pressed pieces 251d and 251e. The slits 251f and 251g may be used to prevent the movable contact unit 260 from being dropped from the contact holder 251.

The insertion hole 251h may be formed at a lower surface portion of the contact holder 251. The pin 214 of the outer case 210 may be inserted into the insertion hole 251h. A circular recess (not shown) may be formed around the insertion hole 251h at the lower side of the lower surface portion of the contact holder 251. The recess may have an outer diameter slightly larger than an outer diameter of the insertion hole 251h. Hence, a bottom wall portion may be provided around the insertion hole 251h in the recess. The upper end portion of the coil spring 280 (as described below, for example) may come into contact with the bottom wall portion.

The plate portion 253 may be provided at a front surface of the contact holder 251 such that a plate surface faces a side of the switch device 200. The guided portion 254 may extend from a substantially center portion in the front-rear direction of a lower surface of the plate portion 253. Also, a pressed portion 253a may be provided at a substantially center portion in the front-rear direction of an upper surface of the plate portion 253. The pressed portion 253a may protrude slightly upward. The pressed portion 253a may receive a pressing force from the operating body 270. The surface of the pressed portion 253a may have a substantially spherical shape. As described above, since the surface of the pressed portion 253a is spherical, the driving member 250 can be moved up and down flexibly in accordance with pressing or tilting of the operating body 270.

The movable contact unit 260 may include a pair of elastic members 261 and 262, a pair of insulating members 263 and 264, and a pair of contact members 265 and 266. The elastic members 261 and 262 may use, for example, coil springs. The insulating members 263 and 264 may be molded with, for example, an insulating resin material. The insulating member 263 (264) may include a base 263a (264a), and two protrusions 263b and 263c (264b, 264c) protruding from a surface of the base 263a (264a).

The base 263a (264a) may have a substantially rectangular shape. The two protrusions 263b and 263c (264b, 264c) each may have a substantially rectangular-parallelepiped shape and are arranged at a predetermined interval. The two protrusions 263b and 263c (264b, 264c) may be arranged slightly inside of both ends in the front-rear direction of the base 263a (264a). Also, protruding pieces 263d and 263e (264d, 264e) may be formed at a rear end of the protrusion 263b (264b) arranged at the rear side of the base 263a (264a) and a front end of the protrusion 263c (264c) arranged at the front side of the base 263a (264a). The protruding pieces 263d and 263e (264d, 264e) may protrude slightly in protruding directions of the protrusions 263b and 263c (264b, 264c).

A boss 263f (264f) may be provided at the base 263a (264a) in a region interposed between the two protrusions 263b and 263c (264b, 264c). The boss 263f may protrude outward. The boss 263f (264f) may be used for attaching the contact member 265 (266) to the insulating member 263 (264). The boss 263f (264f) may be inserted into a through hole 265a (266a) of the contact member 265 (266) (as described below, for example), and a distal end portion protruding from the through hole 265a (266a) may be swaged. In FIG. 16, the boss 263f (264f) is illustrated in the form after swaging. A pair of bottomed housing holes 263g and 264g, and a pair of bottomed housing holes 263h and 264h may be formed at rear surfaces of a pair of bases 263a and 264a. The housing holes 263g, 264g, 263h, and 264h may house end portions of the elastic members 261 and 262 (the housing holes 263g and 263h are not shown in FIG. 16).

The contact members 265 and 266 may form movable contacts, and may be formed by punching and bending conductive metal plates. The contact member 265 (266) may have a step shape along a surface of the insulating member 263 (264). The through hole 265a (266a) may be provided at the center portion of the contact member 265 (266). The boss 263f (264f) of the insulating member 263 (264) may be inserted through the through hole 265a (266a). Also, the contacts 265b and 265c (266b, 266c) each having a semispherical shape, for example, may be provided near both ends of the contact member 265 (266).

The operating body 270 may be formed such that a cross-sectional shape of the operating body 270 in a cross-sectional plane parallel to a plane containing extending directions of both the pair of first terminals 230 (the cap pins 51) may have a smaller width at an upper portion than a width at a lower portion. For example, the operating body 270 may have a substantially triangular shape in front view. The operating body 270 may include a vertex portion 271 that may be a distal end portion arranged at an upper end, a bottom surface 272 opposite to the vertex portion 271, a first pressed portion 273 provided at one outline portion with respect to the vertex portion 271, and a second pressed portion 274 provided at the other outline portion different from the first pressed portion 273 with respect to the vertex portion 271. The vertex portion 271, the first pressed portion 273, and the second pressed portion 274 may form an operating portion of the operating body 270.

A recess 272a may be provided at the center of the bottom surface 272. The recess 272a may be provided for housing the pressed portion 253a of the driving member 250. The recess 272a may be a contact portion that may come into contact with the driving member 250. The pressed portion 253a of the driving member 250 may function as a support portion that supports the contact portion. Also, both end portions of the bottom surface 272 may be formed in protruding shapes such that widths of the protruding shapes are decreased toward the lower side. A pair of protrusions 272b and 272c may be provided at front surfaces of lower end portions of the operating body 270. The protrusions 272b and 272c each may have a substantially triangular shape corresponding to the shape of the bottom surface 272. Three vertex portions have arc-like shapes.

The coil spring 280 may function as an elastic member that may restore the operating body 270 of the switch device 200 to an initial state. The pin 214 of the outer case 210 may be inserted into an upper portion of the coil spring 280. The pin 224 of the inner case 220 may be inserted into a lower portion of the coil spring 280. The coil spring 280 may be expanded and contracted while the coil spring 280 is supported by the pins 214 and 224.

The appearance when the switch device 200 is assembled may be substantially the same as the appearance of the switch device 1 according to the first embodiment shown in FIG. 2.

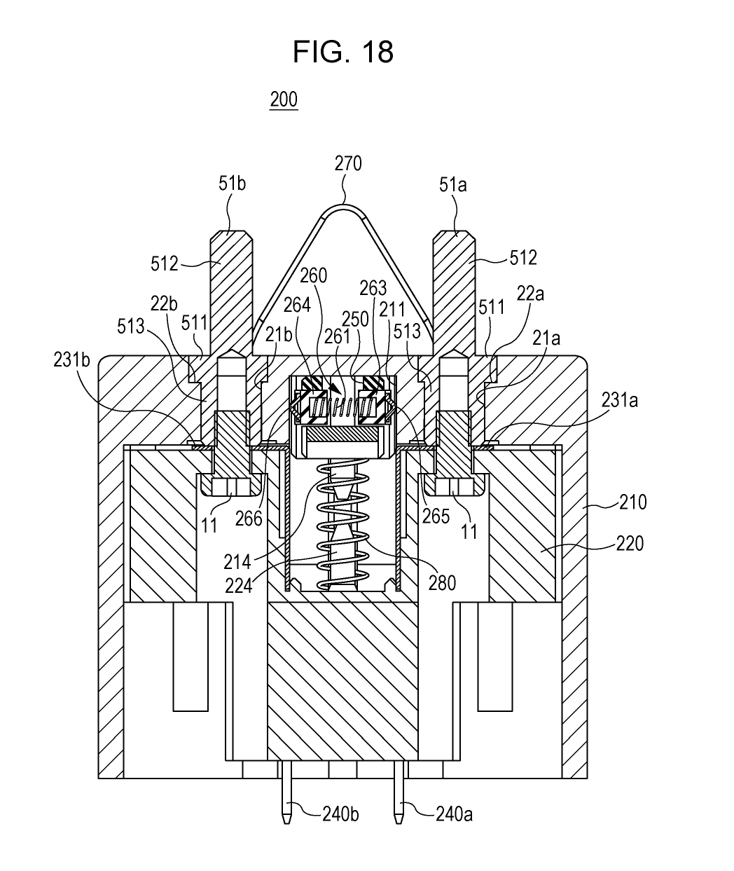

Hereinafter, an inner structure of the switch device 200 according to this embodiment is described. FIG. 18 is a sectional side view of the switch device 200 according to this embodiment. FIG. 18 shows a cross section that passes through the centers of the cap pins 51a and 51b. As shown in FIG. 18, the outer case 210 may house therein components, such as the driving member 250 with the movable contact unit 260 attached and the coil spring 280; and the inner case 220 with the contacts 231 of the first terminals 230 and the second terminals 240 attached. The inner case 220 may be unitized with the outer case 210 by inserting the cap pins 51a and 51b into the through holes 21a and 21b while the inner case 210 may be housed in the outer case 210 from the lower side, and by fixing the cap pins 51a and 51b with the fixing screws 11 from the lower side.

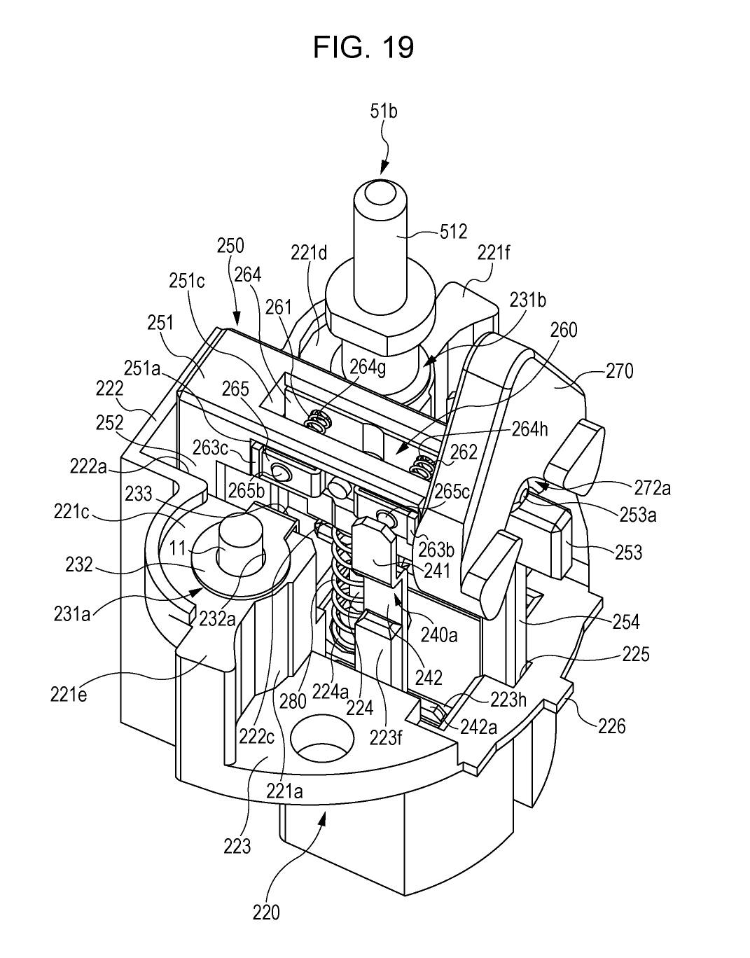

FIG. 19 is a perspective view for explaining components in the periphery of the inner case 220 of the switch device 200 according to this embodiment. FIG. 19 corresponds to a state in which the outer case 210 is removed from the switch device 200 shown in FIG. 19. In FIG. 19, illustration of the cap pin 51a of the first terminal 230 is omitted for convenience of the description. FIG. 20 is a top view of the inner case 220 and its peripheral components in a state shown in FIG. 19.

As shown in FIGS. 19 and 20, the driving member 250 may be arranged in the inner case 220. The driving member 250 may be arranged such that the guided portion 252 is housed in the housing portion 222a and the guided portion 254 is housed in the recess 225. The contact holder 251 may be arranged in the housing portion 211 provided at the lower surface of the outer case 210 (see FIG. 18). The contact holder 251 may hold the movable contact unit 260. To attach the movable contact unit 260, the insulating member 263 with the contact member 265 attached may be arranged at the opening 251a of the contact holder 251 such that the contacts 265b and 265c face outside. The protruding front end portion of the base 263a may be inserted into the slit 251f of the contact holder 251 and may be held. Similarly, the insulating member 264 with the contact member 266 attached may be arranged at the opening 251b of the contact holder 251 such that the contacts 266b and 266c face outside. The protruding front end portion of the base 264a may be inserted into the slit 251g of the contact holder 251 and may be held. The both ends of the elastic member 261 may be housed in the pair of housing holes 263g and 264g, and the both ends of the elastic member 262 may be housed in the pair of housing holes 263h and 264h. Thus, the movable contact unit 260 can be attached to the contact holder 251.

The coil spring 280 may be arranged below the contact holder 251. A lower end portion of the coil spring 280 may be housed in a recess 224a such that the pin 224 is inserted into the coil spring 280 from the lower end portion. Also, an upper end portion of the coil spring 280 may be housed in the recess provided at the lower surface of the contact holder 251 such that the pin 214 of the outer case 210 may be inserted into the coil spring 280 from the upper end portion (see FIG. 18). Accordingly, an urging force for urging the contact holder 251 to the upper side may act on the driving member 250. The operating body 270 may be arranged above the pressed portion 253a of the plate portion 253. The operating body 270 may be arranged such that the recess 272a provided at the bottom surface 272 houses the pressed portion 253a. The urging force of the coil spring 280 acting on the driving member 250 may cause a force for moving the operating body 270 upward to constantly act on the operating body 270. Since the operating body 270 may be housed in the housing portion 26 of the outer case 210 and hence a movable range of the operating body 270 may be limited, the operating body 270 may not be dropped from the pressed portion 253a.

The flat surfaces 232 of the contacts 231 (231a, 231b) of the first terminals 230 may be arranged on the flat surfaces 221c and 221d of the walls 221a and 221b. In this case, the flat surfaces 232 may be arranged such that the openings 232a may correspond to the insertion holes 221g and 221h and the strip-like terminals 233 may extend along the inner wall surface that defines the box-like portion 222. Lower end portions of the strip-like terminals 233 may be inserted into the slits 222b and 222c.

The fixing screws 11 may be inserted into the insertion holes 221g and 221h from the lower side of the inner case 220, and may penetrate through the openings 232a of the contacts 231. The cap pins 51 of the first terminals 230 may be fixed to the fixing screws 11 protruding from the openings 232a. When surfaces of the contacts 231 are fixed, lower surfaces of the fixing portions 513 of the cap pins 51 may be in contact with the flat surfaces 232 of the contacts 231. Accordingly, the cap pins 51 and the contacts 231 may be brought into conduction.

The second terminals 240 may be arranged such that the strip-like terminals 242 may extend along the prisms 223f and 223g and the lower ends of the strip-like terminals 242 may be inserted into the slits 223h and 223i. At this time, the protruding pieces 242a of the strip-like terminals 242 may be exposed from upper opening edges of the slits 223h and 223i. Also, portions of the wall surface portion that defines the housing portion 211 of the outer case 210 may be arranged between the distal end portion 241 and the contact 265c, and between the distal end portion 241 and the contact 266c. Accordingly, in the initial state of the switch device 200, the second terminals 240 and the contacts 265c and 266c may be reliably brought into an insulating state.

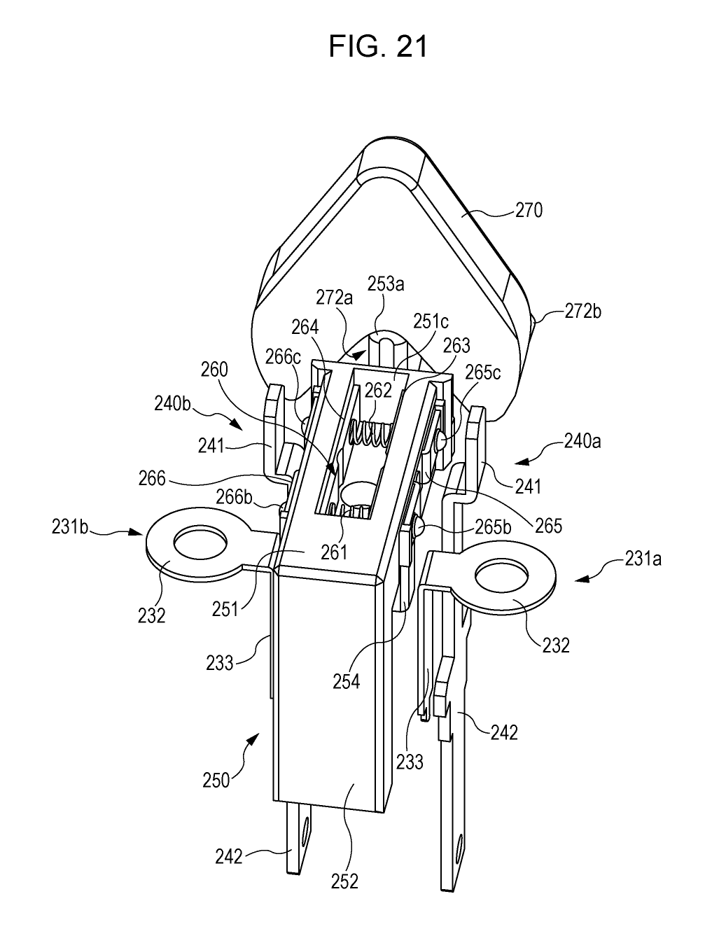

FIG. 21 is an explanatory view of a positional relationship among the components in the switch device 200. FIG. 21 shows a perspective view of the positional relationship among the components in the switch device 200 when viewed from the rear side. FIG. 21 shows a case in which the operating body 270 is in a non-operation state.

When the operating body 270 is in the non-operation state, the driving member 250 may receive the urging force of the coil spring 280 and may be arranged such that part of the guided portion 252 may be housed in the housing portion 222a and part of the guided portion 254 may be housed in the recess 225. The insulating member 263 and the contact member 265, and the insulating member 264 and the contact member 266 of the movable contact unit 260 may receive the urging forces of the elastic members 261 and 262. Accordingly, the contacts 265b and 265c may protrude from the opening 251a and may be arranged outside the contact holder 251. Also, the contacts 266b and 266c may protrude from the opening 251b and may be arranged outside the contact holder 251.

The contact 265b of the movable contact unit 260 may be arranged to face the contact 231a of the first terminal 230. Also, the contact 266b may be arranged to face the contact 231b. Since the contacts 231a and 231b of the first terminals 230 are located below the contacts 265b and 265c, the contact 231a may be separated from the contact 265b, and the contact 231b may be separated from the contact 266b. The contact 265c of the movable contact unit 260 may be arranged to face the distal end portion 241 of the second terminal 240a. Also, the contact 266c may be arranged to face the distal end portion 241 of the second terminal 240b. Since portions of the wall surface portion that defines the housing portion 211 of the outer case 210 may be arranged between the distal end portion 241 and the contact 265c and between the distal end portion 241 and the contact 266c, the second terminal 240a may be separated from the contact 265c, and the second terminal 240b may be separated from the contact 266c. Accordingly, when the switch device 200 is in the initial state, the first terminal 230 and the contacts 265b and 266b, as well as the second terminals 240 and the contacts 265c and 266c may be brought into an insulating state.

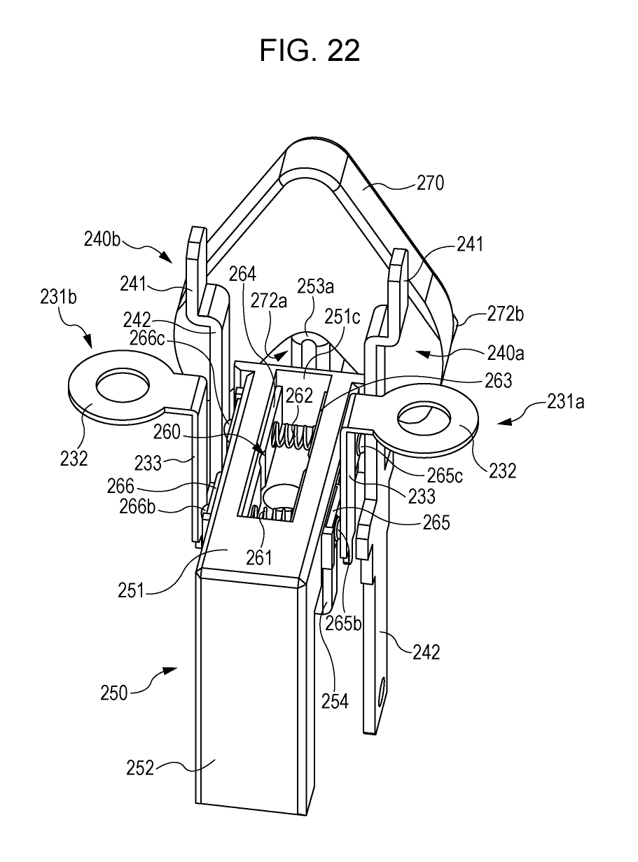

FIG. 22 is a perspective view showing a state of the components in the switch device 200 when the switch device 200 is attached to the first-type fluorescent-lamp fixture A. FIG. 22 only shows the components shown in FIG. 21 for convenience of the description. When the operating body 270 is pressed into the outer case 210 (the housing portion 26), as shown in FIG. 22, the pressed portion 253a of the plate portion 253 with the operating body 270 placed may be pushed downward. Hence, the plate portion 253 of the driving member 250 may be pushed downward against the urging force of the coil spring 280, and the guided portions 252 and 254 may move downward while being guided by inner wall surfaces of the housing portion 222a and the recess 225.

By the movement of the driving member 250, the movable contact unit 260 attached to the contact holder 251 also may be moved downward. When the contacts 265b, 266b, 265c, and 266c respectively reach the strip-like terminals 233 (the first contacts) of the contacts 231a and 231b and the strip-like terminals 242 (the second contacts) of the second terminals 240a and 240b, the first contacts may come into contact with the second contacts. By further movement of the driving member 250, the contacts 265b, 266b, 265c, and 266c may move downward while holding the contact state between the first contacts and the second contacts. At this time, the contacts 265b, 266b, 265c, and 266c may be pushed inward by the strip-like terminals 233 and 242. Hence, the insulating members 263 and 264 and the contact members 265 and 266 of the movable contact unit 260 may be pushed against the urging forces of the elastic members 261 and 262, and move slightly inward. With this configuration, the contacts 265b, 266b, 265c, and 266c respectively may come into contact with the first contacts and the second contacts (a state shown in FIG. 22). When the contacts 265b and 265c respectively come into contact with the first contact and the second contact, the one first terminal 230 and the one second terminal 240 may be brought into conduction through the contact member 265. Similarly, when the contacts 266b and 266c respectively come into contact with the first contact and the second contact, the other first terminal 230 and the other second terminal 240 may be brought into conduction through the contact member 266. Accordingly, a state may be changed to an ON state in which electricity can be applied to the driving circuit (AC/DC converter) mounted on the straight-tube LED lamp.

In contrast, when the switch device 200 is removed from the first-type fluorescent-lamp fixture A, the pressing operation on the operating body 270 may be released. Hence, the contact holder 251 of the driving member 250 may be pushed upward by the urging force of the coil spring 280, and the guided portions 252 and 254 may move upward while being guided by the inner wall surfaces of the housing portion 222a and the recess 225. By the movement of the driving member 250, the contacts 265b, 266b, 265c, and 266c of the movable contact unit 260 may move upward to positions at which the contacts 265b, 266b, 265c, and 266c do not contact the first contact or the second contact (a state shown in FIG. 21). Accordingly, the pressing operation on the contacts 265b, 266b, 265c, and 266c may be released. The insulating members 263 and 264 and the contact members 265 and 266 of the movable contact unit 260 may move outward by the urging forces of the elastic members 261 and 262. When the contacts 265b, 266b, 265c, and 266c do not contact the first contact or the second contact, the first terminals 230 and the second terminals 240 may be brought out of conduction, and a state may be changed to an OFF state in which electricity is not applied to the driving circuit mounted on the straight-tube LED lamp.

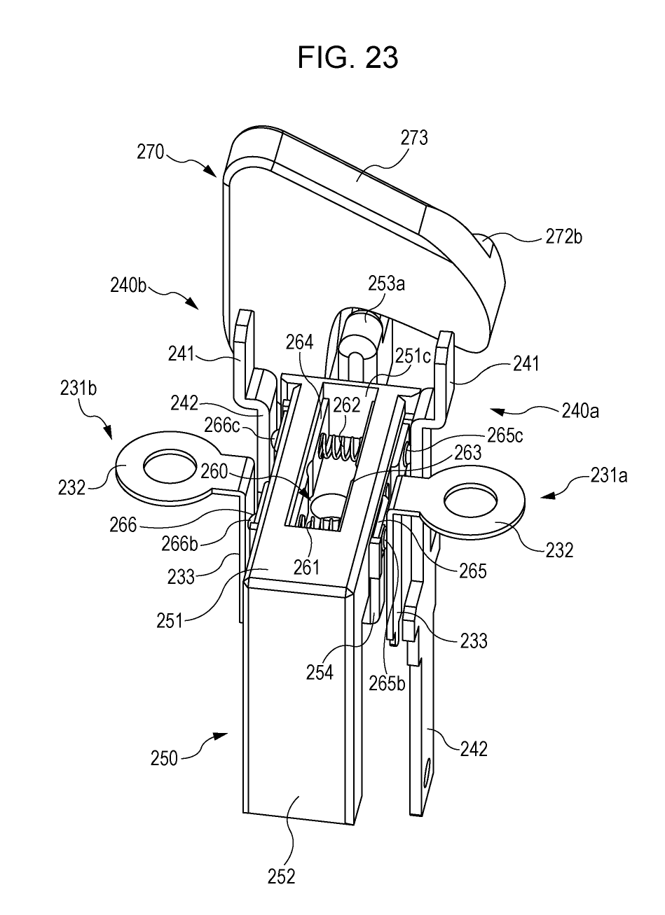

FIG. 23 is a perspective view showing a state of the components in the switch device 200 when the switch device 200 is attached to the second-type fluorescent-lamp fixture B. FIG. 23 only shows the components shown in FIG. 21 for convenience of the description. When the operating body 270 is pressed into the outer case 210 (the housing portion 26), as shown in FIG. 23, the pressed portion 253a of the driving member 250 is pushed downward by the recess 272a of the operating body 270. Also, since the operating body 270 is tilted as shown in FIG. 23, the bottom surface 272 of the operating body 270 may push the pressed piece 251e of the driving member 250 is pushed downward. Hence, the contact holder 251 of the driving member 250 may be pushed downward against the urging force of the coil spring 280, and the guided portions 252 and 254 move downward while being guided by the inner wall surfaces of the housing portion 222a and the recess 225.

By the movement of the driving member 250, the movable contact unit 260 attached to the contact holder 251 also may be moved downward. When the contacts 265b, 266b, 265c, and 266c respectively reach the strip-like terminals 233 (the first contacts) of the contacts 231a and 231b and the strip-like contacts 242 (the second contacts) of the second terminals 240a and 240b, the first contacts may come into contact with the second contacts. By further movement of the driving member 250, the contacts 265b, 266b, 265c, and 266c may move downward while holding the contact state between the first contacts and the second contacts. At this time, the contacts 265b, 266b, 265c, and 266c may be pushed inward by the strip-like terminals 233 and 242. Hence, the insulating members 263 and 264 and the contact members 265 and 266 of the movable contact unit 260 may be pushed against the urging forces of the elastic members 261 and 262, and move slightly inward. With this configuration, the contacts 265b, 266b, 265c, and 266c respectively reliably may come into contact with the first contacts and the second contacts (a state shown in FIG. 23). When the contacts 265b and 265c respectively come into contact with the first contact and the second contact, the one first terminal 230 and the one second terminal 240 may be brought into conduction through the contact member 265. Similarly, when the contacts 266b and 266c respectively come into contact with the first contact and the second contact, the other first terminal 230 and the other second terminal 240 may be brought into conduction through the contact member 266. Accordingly, a state may be changed to an ON state in which electricity can be applied to the driving circuit (AC/DC converter) mounted on the straight-tube LED lamp.

When the operating body 270 moves to the state shown in FIG. 23, by the pressing operation from the lateral side, the operating body 270 may be tilted, one of the first pressed portion 273 and the second pressed portion 274 come into contact with the inner wall surface 26a or the inner wall surface 26b that is the guide portion of the housing portion 26, and then may be pushed into the housing portion 26. To perform the pushing operation into the housing portion 26 after the tilting, the switch device 200 according to this embodiment may be configured such that, in a state in which a pressed portion (an inclination portion) of one of the first pressed portion 273 and the second pressed portion 274 may come into contact with the inner wall surface 26a or the inner wall surface 26b of the housing portion 26 by the tilting, the other pressed portion (the inclination portion) may protrude from the opening 23. Accordingly, the pushing operation after the tilting can be reliably performed. The conduction between the first terminals 230 and the second terminals 240 can be ensured.

In contrast, when the switch device 200 is removed from the second-type fluorescent-lamp fixture B, the pressing operation on the operating body 270 may be released. Hence, the contact holder 251 of the driving member 250 may be pushed upward by the urging force of the coil spring 280, and the guided portions 252 and 254 may move upward while being guided by the inner wall surfaces of the housing portion 222a and the recess 225. By the movement of the driving member 250, the contacts 265b, 266b, 265c, and 266c of the movable contact unit 260 move upward to positions at which the contacts 265b, 266b, 265c, and 266c do not contact the first contacts or the second contacts (the state shown in FIG. 21). Accordingly, the pressing operation on the contacts 265b, 266b, 265c, and 266c may be released. The insulating members 263 and 264 and the contact members 265 and 266 of the movable contact unit 260 may move outward by the urging forces of the elastic members 261 and 262. When the contacts 265b, 266b, 265c, and 266c do not contact the first contact or the second contact, the first terminals 230 and the second terminals 240 may be brought out of conduction, and a state may be changed to an OFF state in which electricity is not applied to the driving circuit mounted on the straight-tube LED lamp.

The relationship between the first terminals 230 (the cap pins 51) and the operating body 270 when the straight-tube LED lamp L is attached to the first-type fluorescent-lamp fixture A and the second-type fluorescent-lamp fixture B may be similar to the relationship in the case of the switch device 1 according to the embodiment shown in FIGS. 13A to 13C, and hence the detailed description is omitted. In other words, in the switch device 200, the operating body 270 may be pressed into the housing (the outer case 210) before the first terminals 230 (the cap pins 51) come into contact with the electrodes A4 (the connected terminals) in the socket A1, and the first terminals 230 and the second terminals 240 are brought into conduction.

As described above, in the switch device 200 according to this embodiment, since the position of the distal end portion of the operating body 270 in the initial state may protrude outside of the positions of the distal end portions of the first terminals 230 (the cap pins 51), the operating body 270 can come into contact with the socket A1 (B1) before the first terminals 5 (see FIGS. 11A and 11B, and 14A and 14B). Accordingly, the operating body 270 can receive the pressing operation into the housing regardless of the positions of the electrodes A4 (the connected terminals) in the socket A1 (B1). By the pressing operation, the first terminals 230 and the second terminals 240 can be brought into conduction. Even if the positions of the electrodes A4 and the like vary in the socket A1 (B1), a state can be reliably changed to an ON state in which electricity can be applied to the driving circuit that causes the LED to emit light.

Also, in the switch device 200 according to this embodiment, not only the pressing operation is performed to the inside of the housing (the outer case 210), but also the operating body 270 may be tilted by the pressing operation from the one side or the other side that are opposite to each other with respect to the protruding directions of the first terminals 230 (the cap pins 51). Hence, at least part of the operating body 270 may be housed in the housing, and the first terminals 230 may be brought into conduction with the second terminals 240. Accordingly, even when the switch device 200 is attached to a fluorescent-lamp fixture of any of a type configured such that a terminal at one end of a straight-tube fluorescent lamp is inserted into one socket and then a terminal at the other end is inserted into the other socket and a type configured such that both terminals are simultaneously attached to sockets, the operating body 270 can be housed in the housing portion 26 and the first terminals 230 can be brought into conduction with the second terminals 240. The switch device 1 can be attached to any type of the fluorescent-lamp fixture.

The present invention is not limited to the above-described embodiments, and may be implemented by modifying the embodiments in various ways. The sizes and shapes of the components shown in the attached drawings are not limited to those in the above-described embodiments. The sizes and shapes of the components may be properly changed within a range that attains advantages of the present invention. The present invention may be implemented by modifying other configurations within the scope of the present invention.

For example, in any of the above-described embodiments, the operating body 9 (270) may be tilted by the pressing operation from both sides of opposite directions with respect to the protruding directions of the first terminals 5 (230) (the cap pins 51). However, the motion of the operating body 9 (270) is not limited thereto, and may be properly changed. For example, the operating body 9 (270) may be tilted by a pressing operation from the one side of the opposite directions with respect to the protruding directions of the first terminals 5 (230). Even with this modification, an advantage similar to that of the embodiments can be attained.

Also, in any of the above-described embodiments, the pair of first terminals 5 (230) is provided, and the pair of second terminals 6 (240) and the pair of movable contacts 7 (the contact members 265, 266) are provided to correspond to the pair of first terminals 5 (230). The above-described embodiments can be used for a straight-tube LED lamp with a configuration in which power is fed from the one switch device 1 (200) provided at an end of a lamp body. However, the number of the second terminals 6 (240) and the number of the movable contacts 7 (the contact members 265, 266) included in the switch device 1 (200) are not limited to the numbers in any of the above-described embodiments, and may be properly changed. For example, when the embodiments are applied to the straight-tube LED lamp having a power-feed structure using switch devices 1 (200) provided at each of both ends of a lamp body, the single second terminal 6 (240) and the single movable contact 7 (the contact member 265, 266) may be provided at each of both ends. In this case, the conduction state between one of the pair of first terminals 5 (230) and the single second terminal 6 (240) may be changed through the single movable contact 7 (the contact member 265). Hence, the conduction state of the other of the pair of first terminals 5 (230) with respect to the second terminal is not changed. Alternatively, the pair of first terminals may be conducting with each other in the housing of the switch device 1, and the conduction state between both the first terminals and the single second terminal may be changed.

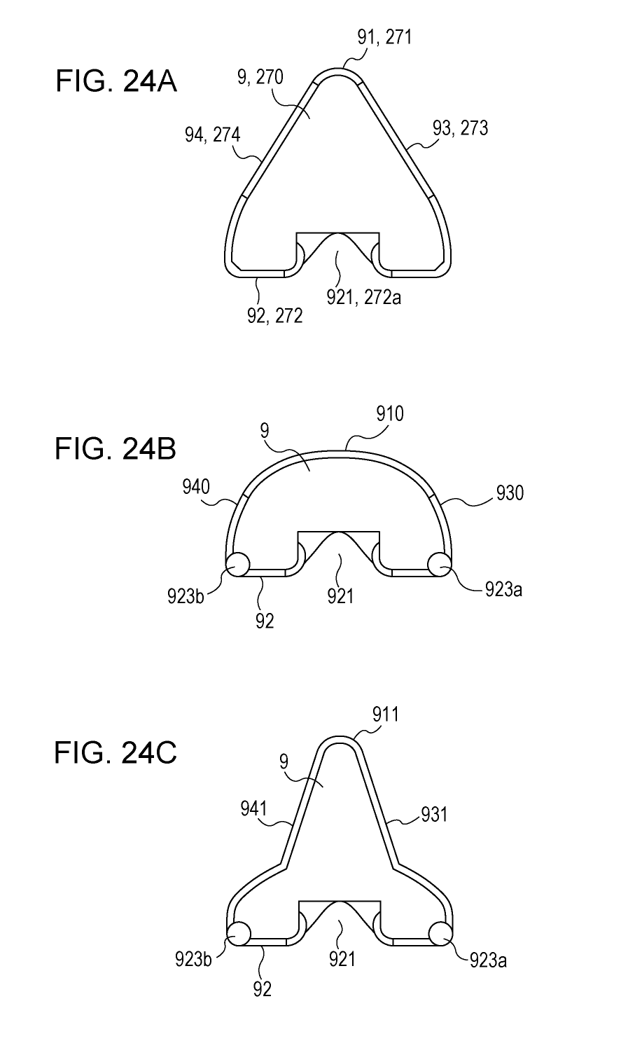

Further, for the operating body 9 (270) of any of the above-described embodiments, as shown in FIG. 24A, the first pressed portion 93 (273) and the second pressed portion 94 (274) have the inclination portions. However, the shape of the operating body 9 (270) is not limited thereto, and may be properly changed. For example, the first pressed portion and the second pressed portion may be formed of curved portions, such as a first pressed portion 930 and a second pressed portion 940 shown in FIG. 24B. Alternatively, the first pressed portion and the second pressed portion may be formed of combinations of curved portions and straight portions, such as a first pressed portion 931 and a second pressed portion 941 shown in FIG. 24C. Also, the vertex portions at the distal end portions of the operating body 9 (270) each do not have to have a small curvature radius, such as a vertex portion 91 shown in FIG. 24A and a vertex portion 911 shown in FIG. 24C, and may have a large curvature radius, such as a vertex portion 910 shown in FIG. 24B. The vertex portion does not have to have an arc-like shape.

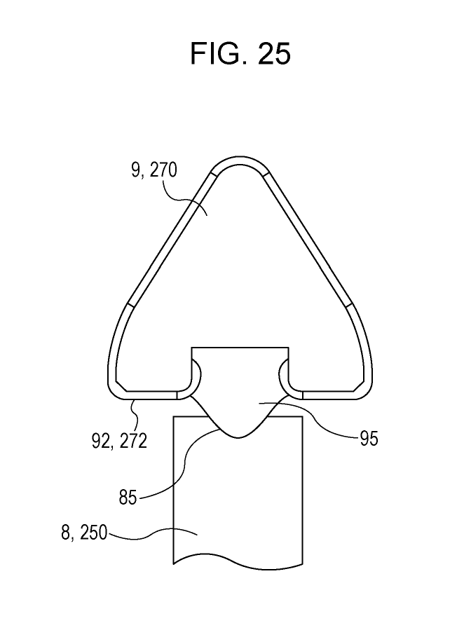

Further, for the operating body 9 (270) of any of the above-described embodiments, the recess 921 (272a) may be provided at the center of the bottom surface 92 (272). However, the shape of the operating body 9 (270) is not limited thereto, and may be properly changed. For example, as shown in FIG. 25, a protrusion 95 may be provided at the center of the bottom surface 92 (272). In this case, the protrusion 95 may be housed in a recess 85 provided at the driving member 8 (250). The protrusion 95 is a contact portion that comes into contact with the driving member 8 (250). The recess 85 of the driving member 8 (250) functions as a support portion that supports the contact portion.

Further, for the operating body 9 (270) of any of the above-described embodiments, the two protrusions 922a and 922b (the protrusions 923a and 923b, or the protrusions 272b and 272c) are provided. However, the number of protrusions provided at the operating body 9 (270) is not limited thereto, and may be properly changed. For example, a continuously extending single protrusion may be provided.

Further, in any of the above-described embodiments, the operating body 9 (270) has a plate-like shape. However, the shape of the operating body 9 (270) is not limited thereto, and may be properly changed. For example, the shape of the operating body 9 (270) may be a cone, or a shape having a plurality of steps.

Further, in any of the above-described embodiments, the operating body 9 (270) may be arranged in the plane parallel to the plane containing the protruding directions of the pair of first terminals 5 (230), the plane which is arranged at the front side of the plane containing the first terminals 5 (230). However, the position of the operating body 9 (270) is not limited thereto, and may be properly changed. For example, the operating body 9 (270) may be arranged in the same plane as the plane containing the protruding directions of the pair of first terminals 5 (230).

Further, in any of the above-described embodiments, the housing portion 26 may be provided at the outer case 2 (210). However, the member provided with the housing portion 26 is not limited to the outer case 2 (210), and may be properly changed. For example, the housing portion 26 may be provided at a member different from the outer case 2 (210). Also, the housing of the switch device 1 (200) may be integrally formed with at least part of the housing of the LED lamp body.

Further, in any of the above-described embodiments, the switch devices 1 (200) may be provided at both ends of the straight-tube LED lamp L. However, the positions at which the switch devices 1 (200) are provided at the straight-tube LED lamp L are not limited thereto, and may be properly changed. For example, when the switch device is attached to the fluorescent-lamp fixture with the structure in which power is fed only from one end of the straight-tube LED lamp L, the switch device 1 (200) may be provided only at the one end of the straight-tube LED lamp L. When the switch device 1 (200) is provided only at the one end of the straight-tube LED lamp L, the other end of the straight-tube LED lamp L may be provided with a dummy terminal or the like and may be attached to a corresponding socket.

Further, in the first embodiment, the switch device 1 includes the cam bodies 10 and the movable contacts 7 as separate members, and the cam bodies 10 are held by the movable contacts 7. However, the configurations of the cam bodies 10 and the movable contacts 7 included in the switch device 1 are not limited thereto, and may be properly modified. For example, the cam bodies 10 may be integrally molded with the movable contacts 7 by insert molding.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A straight-tube light-emitting diode lamp switch device, comprising:
a housing having an opening;
a pair of first terminals that protrude from the housing in one direction and can come into contact with electrodes in a socket of a lamp fixture;
an operating body including an operating portion that protrudes from the opening in the one direction and can receive a pressing operation into the housing;
a second terminal having a conduction state, the conduction state of the second terminal with respect to one of the pair of first terminals being changed by the pressing operation on the operating body; and
an elastic member that restores the operating body to an initial state before the pressing operation,
wherein a position of a distal end portion of the operating body in the initial state protrudes in the one direction with respect to positions of distal end portions of the pair of first terminals.

2. The straight-tube light-emitting diode lamp switch device according to claim 1, wherein, when the pressing operation is performed on the operating body by the socket, the operating body is pressed into the housing by the socket before the first terminals come into contact with the electrodes, and the one of the pair of first terminals and the second terminal are brought into conduction.

3. The straight-tube light-emitting diode lamp switch device according to claim 2, wherein the distal end portions of the pair of first terminals are housed in holes provided at the socket at the time when the one of the pair of first terminals and the second terminal are brought into conduction.

4. The straight-tube light-emitting diode lamp switch device according to claim
wherein the housing has therein a housing portion that houses the operating portion when the pressing operation is performed on the operating body,
wherein the operating body is tilted by a pressing operation from at least one side of opposite directions with respect to the one direction of the first terminals, and
wherein, by the tilting, at least part of the operating portion is housed in the housing portion, and the one of the first terminals and the second terminal are brought into conduction.

5. The straight-tube light-emitting diode lamp switch device according to claim 4,
wherein the housing portion includes a guide portion that guides the operating body when the operating portion is housed by the pressing operation on the operating body,
wherein the operating portion includes a first pressed portion that receives a pressing operation from the one side, and
wherein the operating body is tilted and pushed into the housing portion by the pressing operation from the one side.

6. The straight-tube light-emitting diode lamp switch device according to claim 5,
wherein a cross-sectional shape of the operating portion in a cross-sectional plane parallel to a plane containing extending directions of both the pair of first terminals has a smaller width at a vertex portion at a distal end than a width at a portion near the opening,
wherein the first pressed portion is provided at one outline portion with respect to the vertex portion of the cross-sectional shape, and
wherein the tilting by the pressing operation from the one side is movement along the plane containing the extending directions of both the pair of first terminals.

7. The straight-tube light-emitting diode lamp switch device according to claim 6,
wherein the operating body includes a protrusion protruding in a direction intersecting with the cross-sectional plane, and
wherein, in the initial state, the protrusion is supported by a support portion provided at the housing portion.

8. The straight-tube light-emitting diode lamp switch device according to claim 5,
wherein the operating body includes a second pressed portion that receives a pressing operation from the other side opposite to the one side with respect to the one direction of the first terminals,
wherein the operating body is tilted and pushed into the housing portion by the pressing operation from the other side,
wherein the first pressed portion and the second pressed portion respectively have a first inclination portion and a second inclination portion having angles smaller than 90 degrees with respect to a surface of the housing having the opening, and
wherein, when one inclination portion of the first inclination portion and the second inclination portion comes into contact with the guide portion of the housing portion by the tilting as the result of the pressing operation from the one side or the other side, the other inclination portion protrudes from the opening.

9. The straight-tube light-emitting diode lamp switch device according to claim 1, further comprising:
a movable contact that changes a conduction state between the one of the first terminals and the second terminal; and
a driving member that is moved by the pressing operation on the operating body and drives the movable contact,
wherein the driving member is arranged to move in a region between the pair of first terminals.

10. The straight-tube light-emitting diode lamp switch device according to claim 9,
wherein the operating body is arranged in a region different from the region between the pair of first terminals, and includes a contact portion that is arranged at a position opposite to a distal end of the operating portion and that comes into contact with the driving member, and
wherein the driving member includes a support portion that supports the contact portion, and the support portion is urged to the contact portion by the elastic member.

11. The straight-tube light-emitting diode lamp switch device according to claim 10,
wherein the contact portion of the operating body is a recess, and
wherein the support portion of the driving member is a protrusion.

12. The straight-tube light-emitting diode lamp switch device according to claim 4,
wherein the housing portion that houses the operating portion is provided in one region in the housing with respect to the plane containing the extending directions of both the pair of first terminals, and
wherein a movable contact that changes a conduction state between the one of the pair of first terminals and the second terminal is provided in the other region in the housing with respect to the plane containing the extending directions of both of the pair of first terminals.

13. The straight-tube light-emitting diode lamp switch device according to claim 12, wherein the movable contact is formed of a member different from the pair of first terminals and the second terminal, is arranged to face a first contact that is provided in conduction with the one of the pair of first terminals and a second contact that is provided in conduction with the second terminal, and comes into contact with the first contact and the second contact by the pressing operation on the operating body.

14. The straight-tube light-emitting diode lamp switch device according to claim 13,
wherein the operating body has a recess to face a distal end of the operating portion,
wherein a driving member being able to perform a seesaw motion is arranged to pass through a region between the pair of first terminals, one end portion of the driving member being arranged in the recess, the other end portion of the driving member driving the movable contact, and
wherein the one end portion of the driving member is urged to the recess by the elastic member.

15. The straight-tube light-emitting diode lamp switch device according to claim 13,
wherein a pair of the second terminals and a pair of the movable contacts are provided respectively for the pair of first terminals, and
wherein conduction states are changed through the movable contacts respectively corresponding to the first terminals and the second terminals.

16. A straight-tube light-emitting diode lamp, comprising:
a plurality of light-emitting diodes;
a driving circuit that causes the light-emitting diodes to emit light;
a cylindrical lamp body that houses the plurality of light-emitting diodes and the driving circuit; and
the straight-tube light-emitting diode lamp switch device according to claim 1 provided at an end of the lamp body.
